(19) United States
(12) Patent Application Publication
(10) Pub. No.: US 2025/0184753 A1
(43) Pub. Date: Jun. 5, 2025

(54) INTERFERENCE EVALUATION METHOD, INTERFERENCE EVALUATION APPARATUS AND INTERFERENCE EVALUATION PROGRAM

(71) Applicant: Nippon Telegraph and Telephone Corporation, Tokyo (JP)

(72) Inventors: Hideyuki TSUBOI, Musashino-shi, Tokyo (JP); Kazuto GOTO, Musashino-shi, Tokyo (JP); Hideki TOSHINAGA, Musashino-shi, Tokyo (JP); Naoki KITA, Musashino-shi, Tokyo (JP); Takeshi ONIZAWA, Musashino-shi, Tokyo (JP)

(21) Appl. No.: 18/842,239

(22) PCT Filed: Mar. 9, 2022
(86) PCT No.: PCT/JP2022/010300

§ 371 Date: Aug. 28, 2024

(51) Int. Cl. H04W 16/18; H04B 17/345

(52) U.S. Cl. CPC H04W 16/18; H04B 17/345

(57) ABSTRACT

An interference evaluation method is an interference evaluation method executed by an interference evaluation device, the interference evaluation method including: a step of deriving coordinates of an evaluation range in a real space on the basis of a range designated using a map, and deriving coordinates of a radio station in the real space on the basis of a position designated using the map; a step of deriving an interference level of a radio wave transmitted from the radio station for the evaluation range on the basis of the coordinates of the evaluation range and the coordinates of the radio station; and a step of displaying an image corresponding to the interference level on a display unit. The interference evaluation method further include: a step of deriving coordinates of a path range that can include a three-dimensional path in the real space on the basis of a second range designated within a first range using the map; and a step of deriving coordinates of the three-dimensional path on the basis of a path designated using the map.

### TECHNICAL FIELD

The present invention relates to an interference evaluation method, an interference evaluation device, and an interference evaluation program.

### BACKGROUND ART

In the interference evaluation of radio waves in wireless communication, positions of a plurality of radio stations using radio waves of the same frequency are adjusted according to a result of the interference evaluation. For example, the radio stations may be disposed at positions separated from each other by a distance corresponding to the result of the interference evaluation.

FIG. 25 is a diagram illustrating a first example of a screen of an interference evaluation result (an example of a result of interference evaluation by interference evaluation software). In FIG. 25, an interference allowance area in which another wireless communication system can coexist is displayed without hatching on a map with respect to an interference-evaluated range. In addition, an interference area in which operation and installation conditions of another wireless communication system need to be reviewed is displayed on the map while being distinguished from a hatched area (see Non Patent Literature 1).

FIG. 26 is a diagram illustrating a second example of the screen of the interference evaluation result. In FIG. 26, the position of an interfered station is indicated on the map by a triangle mark. A ridge distance, which is a distance from the interfered station to a ridge, is indicated by a dashed-dotted line surrounding the interfered station. The separation distance in which the ridge distance is considered (separation distance with ridges) is indicated by a dotted line encirclement. In addition, the separation distance having the worst value in the separation distance in which the ridge distance is not considered (separation distance without ridges) is indicated by a solid line encirclement (see Patent Literature 1).

FIG. 27 is a diagram illustrating a screen example of the evaluation result of a radio wave arrival area. In FIG. 27, one interfering station (black circle) and three interfered stations (interfered station A, interfered station B, and interfered station C) (white circles) are illustrated on the map. The antenna direction of the interfering station is indicated by a broken line arrow. An evaluation range including the one interfering station and the three interfered stations is divided into meshes. In each mesh, there is a plurality of types of (power levels of radio wave arrival. ≤−51 dBm, −41 to −50 dBm, −31 to −40 dBm, −21 to −30 dBm, and −10 to −20 dBm) hatching is used to display arrival areas of radio waves transmitted from the interfering station in a distinguishable manner (see Patent Literature 2).

The results of these interference evaluations are expressed on a two-dimensional map, for example, by color coding of areas. As a result, the user can confirm how to adjust the disposition of the radio stations according to the interference evaluation for shared use with another wireless communication system.

### CITATION LIST

### Patent Literature

Patent Literature 1: JP 2019-169815 A

Patent Literature 2: JP 2020-150506 A

### Non Patent Literature

Non Patent Literature 1: “Kansho hyoka software (in Japanese) (Interference Evaluation Software)” [online], Annals of TsuKuBa, NTT Access Network Service Systems Laboratories, 2018, [searched on Feb. 14, 2022], the Internet <URL: https://www.rd.ntt/as/history/wireless/wi0512.html>

### SUMMARY OF INVENTION

### Technical Problem

In order to display the result of the interference evaluation, the evaluation range and the position of the radio station need to be given to an interference evaluation device in advance. When the user designates the evaluation range and the position of the radio station, the evaluation range and the position (longitude and latitude) of the radio station need to be input to the interference evaluation device numerically. In addition, in the adjustment of the position of the radio station, an evaluation result of interference is derived while the user changes the position of the radio station, or the like. Here, the user is required to input the evaluation range and the position of the radio station from the interference evaluation device every time the interference evaluation condition is changed.

Therefore, the user (operator) who uses interference evaluation software (interference evaluation tool) operating in the interference evaluation device cannot intuitively grasp the designated evaluation range and position of the radio station. Therefore, the evaluation range may be too narrow or too broad. In addition, as the position where the radio station is disposed, a position outside the evaluation range may be erroneously input to the interference evaluation device. In such a case, an expected interference evaluation result cannot be obtained.

FIG. 28 is a diagram illustrating an example of an evaluation range (execution condition) designation screen. In FIG. 28, interfering stations (“Station 2” and “Station 3”) and interfered stations (“Station 4” and “Station 1”) are exemplified as “interfering/interfered information”. In FIG. 28, the positions of the interfering stations and the positions of the interfered stations are indicated in an interfering/interfered information setting field 400 by numerical values of latitude and longitude. The latitude and longitude of the upper left coordinate and the lower right coordinate of the evaluation range in which the area is designated as the range of interference evaluation are displayed in an area designation setting field 410 in which numerical values can be set. In addition, FIG. 28 illustrates an interfering station antenna direction setting field 420.

FIG. 29 is a diagram illustrating an example of a radio station position designation screen (a screen for editing a radio station database). That is, FIG. 29 is a screen for setting, confirming, and changing information regarding “Station 4” among the interfered stations listed in the interfering/interfered information. The radio station position designation screen includes fields for the user to enter respective numerical values of latitude, longitude, and altitude as the position of “Station 4”. Here, the entry fields of the respective numerical values of the latitude, longitude, and altitude of the radio station position are radio station position setting fields 430.

When a “save” button at the lower right in FIG. 29 is pressed, “Latitude 1” and “Longitude 1” indicating the position of the interfered station “Station 4” are changed within the interfering information and the interfered information on the screen for designating the execution condition illustrated in FIG. 28. In addition, the changed numerical values of latitude and longitude (for example, “35.73XX” and “139.94XX”) are reflected as the position of the interfered station “Station 4”.

As described above, in the designation of the interference evaluation range and the setting of the position of the radio station, the latitude and longitude are numerically input to the interference evaluation device. Therefore, related information needs to be prepared in advance, which is troublesome for the user. For example, numerical values of latitude and longitude at each end of the evaluation range in a real space are prepared before the interference evaluation is executed. In addition, numerical values of the latitude and longitude of the position of the radio station are prepared before the interference evaluation is executed.

In addition, when a numerical value is input to the interference evaluation device, it is difficult for the user to intuitively understand the evaluation range and the position of the radio station. As described above, in the interference evaluation, there is a problem that the operation of designating the radio wave interference evaluation condition is troublesome.

In view of the circumstances described above, an object of the present invention is to provide an interference evaluation method, an interference evaluation device, and an interference evaluation program capable of reducing the time and effort of an operation for designating a radio wave interference evaluation condition.

### Solution to Problem

An aspect of the present invention is an interference evaluation method executed by an interference evaluation device, the interference evaluation method including: a step of deriving coordinates of an evaluation range in a real space on the basis of a first range designated using a map, and deriving coordinates of a radio station in the real space on the basis of a position designated using the map; a step of deriving an interference level of a radio wave transmitted from the radio station for the evaluation range on the basis of the coordinates of the evaluation range and the coordinates of the radio station; and a step of displaying an image corresponding to the interference level on a display unit.

An aspect of the present invention is an interference evaluation device including: a position derivation unit that derives coordinates of an evaluation range in a real space on the basis of a first range designated using the map described above, and derives coordinates of a radio station in the real space on the basis of a position designated using the map; an interference derivation unit that derives an interference level of a radio wave transmitted from the radio station for the evaluation range on the basis of the coordinates of the evaluation range and the coordinates of the radio station; and an image processing unit that displays an image corresponding to the interference level on a display unit.

An aspect of the present invention is an interference evaluation program for causing a computer to function as the interference evaluation device described above.

### Advantageous Effects of Invention

According to the present invention, it is possible to reduce time and effort of an operation of designating a radio wave interference evaluation condition.

### BRIEF DESCRIPTION OF DRAWINGS

FIG. 1 is a diagram illustrating a configuration example of an interference evaluation device according to a first embodiment.

FIG. 2 is a diagram illustrating an example of an evaluation range designation screen according to the first embodiment.

FIG. 3 is a flowchart illustrating an operation example of the interference evaluation device according to the first embodiment.

FIG. 4 is a flowchart illustrating details of the operation example of the interference evaluation device according to the first embodiment.

FIG. 5 is a diagram illustrating a configuration example of an interference evaluation device according to a second embodiment.

FIG. 6 is a diagram illustrating an example of a designation screen for an evaluation range and a path range according to the second embodiment.

FIG. 7 is a diagram illustrating an example of interference evaluation of a two-dimensional evaluation range according to the second embodiment.

FIG. 8 is a diagram illustrating an example of interference evaluation of a three-dimensional path range according to the second embodiment.

FIG. 9 is a diagram illustrating an example of an antenna pattern according to the second embodiment.

FIG. 10 is a diagram illustrating an example of terrain data according to the second embodiment.

FIG. 11 is a diagram illustrating a setting example of a three-dimensional path having a wire shape according to the second embodiment.

FIG. 12 is a diagram illustrating an example of a screen of an interference evaluation result according to the second embodiment.

FIG. 13 is a flowchart illustrating an operation example of the interference evaluation device according to the second embodiment.

FIG. 14 is a flowchart illustrating details of the operation example of the interference evaluation device according to the second embodiment.

FIG. 15 is a diagram illustrating an example of a screen of an interference evaluation result according to a modification of the second embodiment.

FIG. 16 is a diagram illustrating a configuration example of an interference evaluation device according to a third embodiment.

FIG. 17 is a diagram illustrating a first example of a screen of an interference evaluation result of a three-dimensional path according to the third embodiment.

FIG. 18 is a diagram illustrating a second example of a screen of an interference evaluation result of a three-dimensional path according to the third embodiment.

FIG. 19 is a flowchart illustrating an operation example of the interference evaluation device according to the third embodiment.

FIG. 20 is a flowchart illustrating details of the operation example of the interference evaluation device according to the third embodiment.

FIG. 21 is a diagram illustrating an example of a screen of an interference evaluation result of a three-dimensional path according to a modification of the third embodiment.

FIG. 22 is a flowchart illustrating a first example of an operation of an interference evaluation device according to a fourth embodiment.

FIG. 23 is a flowchart illustrating a second example of an operation of an interference evaluation device according to the fourth embodiment.

FIG. 24 is a diagram illustrating a hardware configuration example of the interference evaluation device according to each embodiment.

FIG. 25 is a diagram illustrating a first example of a screen of an interference evaluation result.

FIG. 26 is a diagram illustrating a second example of a screen of an interference evaluation result. FIG. 27 is a diagram illustrating a screen example of an evaluation result of a radio wave arrival area.

FIG. 28 is a diagram illustrating an example of an evaluation range designation screen.

FIG. 29 is a diagram illustrating an example of a radio station position designation screen.

### DESCRIPTION OF EMBODIMENTS

Embodiments of the present invention will be described in detail with reference to the drawings.

### First Embodiment

Setting (designation) of the evaluation range, which is one of interference evaluation derivation conditions, and setting (designation), confirmation, and change of the position of the radio station, which is one of the interference evaluation derivation conditions, can be performed on a displayed map by a three-stage procedure exemplified below.

In the first stage, the respective positions (coordinates) of the upper left corner and the lower right corner of the evaluation range designated on the map are changed to numerical values of latitude and longitude. The converted numerical values of latitude and longitude are input to the interference evaluation device as the latitude and longitude of the evaluation range.

In the second stage, the interference evaluation device confirms to the user whether or not it is necessary to correct the evaluation range set on the map. When correction is needed, the interference evaluation device returns the processing to the first stage. As a result, the evaluation range is reset. When no correction is needed, the interference evaluation device advances the processing to a third stage.

In the third stage, the user operates an operation unit such as a mouse. The setting of the position of the radio station is executed on the map according to a position designation operation (point operation) or the like by the user. The set position of the radio station is displayed on the map. In particular, similarly to the evaluation range of the first stage, the position of the radio station designated on the map is converted into latitude and longitude. The converted numerical value is used for interference evaluation as the position of the radio station. If necessary, the position of the radio station may be corrected. In addition the position of another radio station (base station) may be added on the map.

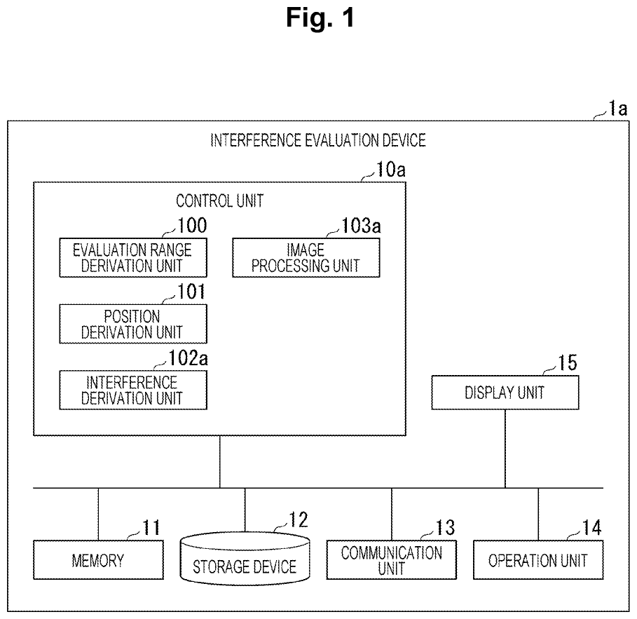

FIG. 1 is a diagram illustrating a configuration example of an interference evaluation device la according to the first embodiment. The interference evaluation device la is an information processing device that evaluates interference of radio waves. The interference evaluation device 1a includes a control unit 10a, a memory 11, a storage device 12, a communication unit 13, an operation unit 14, and a display unit 15. The control unit 10a includes an evaluation range derivation unit 100, a position derivation unit 101, an interference derivation unit 102a, and an image processing unit 103a.

The image displayed on the display unit 15 is, for example, an image of a map including the evaluation range. The map includes position information in a horizontal direction. In addition, the map may include position information (altitude) in a vertical direction.

The evaluation range derivation unit 100 acquires a signal according to the operation by the user from the operation unit 14. The signal according to the operation is, for example, an operation (point operation) of designating a position (coordinates on the map) in the image displayed on the display unit 15.

The position derivation unit 101 converts the position (coordinates on the map) designated on the displayed image into a position (coordinates) in a real space. For example, the position derivation unit 101 converts the coordinates designated on the displayed map using the operation unit 14 (for example, mouse) into latitude and longitude in a real space.

The interference derivation unit 102a derives interference of radio waves from an interfering station (radio station) with respect to the evaluation range designated on the map according to the operation by the user. The image processing unit 103a generates an image to be displayed on the display unit 15. The image displayed on the display unit 15 is, for example, a map. The evaluation result of the radio wave interference may be superimposed on the displayed map.

The memory 11 reads the program and data from the storage device 12. The storage device 12 stores in advance an interference evaluation program, map data, and specification data (for example, frequency data, position data, and the like) of the radio station.

The communication unit 13 executes communication with a predetermined external device (not illustrated). The operation unit 14 receives an operation by the user. The operation unit 14 is, for example, a mouse, a trackball, or a touch panel. The mouse may include a wheel.

The display unit 15 is a display device. For example, the display unit 15 is a liquid crystal display or an organic electro-luminescence (EL) display. The display unit 15 may be integrated with the operation unit 14 (touch panel).

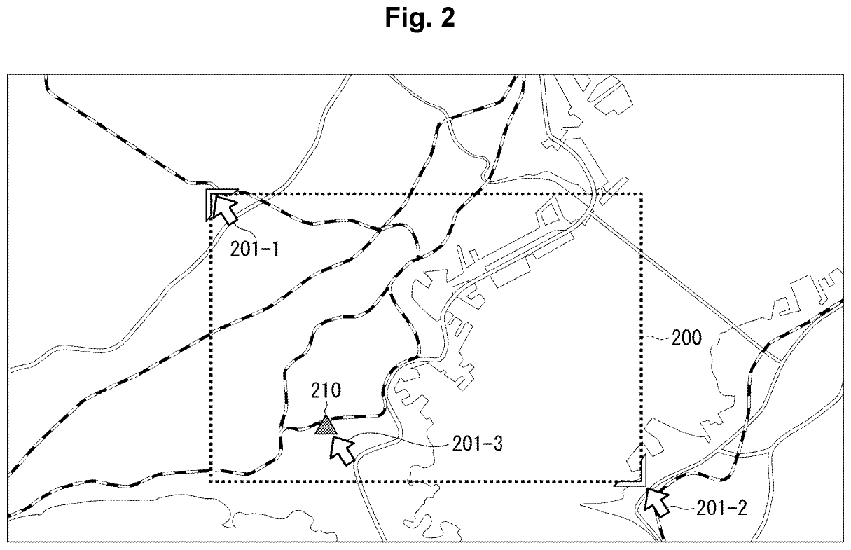

FIG. 2 is a diagram illustrating an example of an evaluation range designation screen according to the first embodiment. The map is displayed on the screen size. The range to be evaluated and the position of the interfering station are set and changed using the pointer (arrow pointing upper left) on the map display. In the operation mode for designating the evaluation range, the operator (user) clicks the left button of the operation unit 14 (mouse) at the position of a pointer 201-1 on the map. As a result, the latitude and longitude of the position to be the upper left corner of the evaluation range are numerically converted and set.

Subsequently, the operator (user) clicks the left button of the operation unit 14 (mouse) at the position of a pointer 201-2 on the map. As a result, the latitude and longitude of the lower right corner of the evaluation range are numerically converted and set. In this way, the evaluation range can be set on the map by a simple operation using the pointer (mouse) with an operation easy for the user to understand. Additionally, in the change of the evaluation range, the already designated evaluation range can be cleared (the numerical values set in the entry fields of the latitude and longitude of the upper left corner and the lower right corner are temporarily deleted), and the evaluation range can be set again as described above. In addition, in a case where the evaluation range is designated in a range surrounded by the dotted line on the map illustrated in FIG. 2, the upside-down inverted L-shape is selected (dragged) by the pointer at the upper left corner of the evaluation range and moved to and released at a change position. The position can be changed to a desired position by this operation. The lower right corner (left-right inverted L-shape) of the evaluation range can be similarly operated. When it is desired to change only one of the upper left corner and the lower right corner, it is possible to change the evaluation range by selecting and moving only the corner to be changed and releasing the corner at a desired position.

Next, an operation method of setting the position of the radio station for interference evaluation will be described. In the operation mode for designating the radio station (interfering station in the drawing), the operator (user) clicks the left button of the operation unit 14 (mouse) at the position of a pointer 201-3 on the map. As a result, a position (a predetermined position within the evaluation range) where an interfering station 210 is to be installed is numerically converted into latitude and longitude in a real space. In addition, a numerical conversion result of the position where the interfering station 210 is to be installed is set.

When the user executes the designation operation using the mouse in this manner, the designation status of the interference evaluation range is displayed on the map using the dotted line encirclement, the upside-down inverted L-shape of the upper left corner, and the left-right inverted L-shape of the lower right corner. As a result, the user can easily perform an operation of installing the radio station within the evaluation range. Of course, in a case where the user designates the evaluation range in a range away from the interfering station 210 and the user wants to examine interference in the evaluation range in detail, the interfering station 210 may be installed outside the evaluation range on the map.

Note that, in a case where the position of the radio station (interfering station 210) is designated on the map prior to the designation of the evaluation range, a triangle mark (hatched triangle mark) indicating the interfering station 210 is displayed on the map. Moreover, when a plurality of interfering stations can be set and displayed on the map, or the interfered station can be displayed with different types and colors of marks, the user can easily set the evaluation range including all the radio stations (the interfering station and the interfered station). In addition, the user can easily set the evaluation range selectively surrounding some radio stations of all the radio stations on the map.

Next, an operation example of the interference evaluation device la will be described.

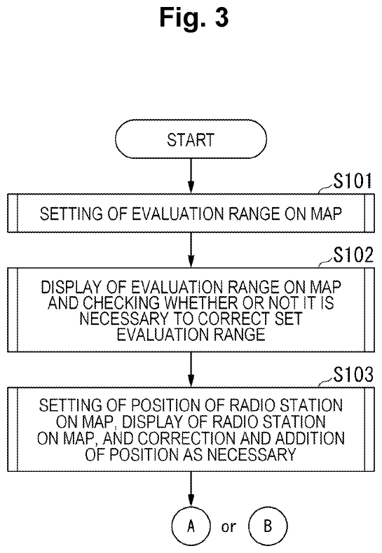

FIG. 3 is a flowchart illustrating an operation example of the interference evaluation device 1a according to the first embodiment. The interference evaluation device 1a sets the interference evaluation range on the map according to the user operation as one of interference evaluation conditions (step S101).

The interference evaluation device 1a displays the evaluation range on the map. The interference evaluation device la checks whether or not it is necessary to correct the set evaluation range (step S102). The interference evaluation device 1a sets the position of the interfering station 210 on the map as the interference evaluation condition. The interference evaluation device 1a displays a symbol (triangle) indicating the interfering station 210 at the position of the interfering station 210 on the map. The interference evaluation device 1a may correct the position of the interfering station 210 on the map. The interference evaluation device la may add the position of another interfering station on the map (step S103).

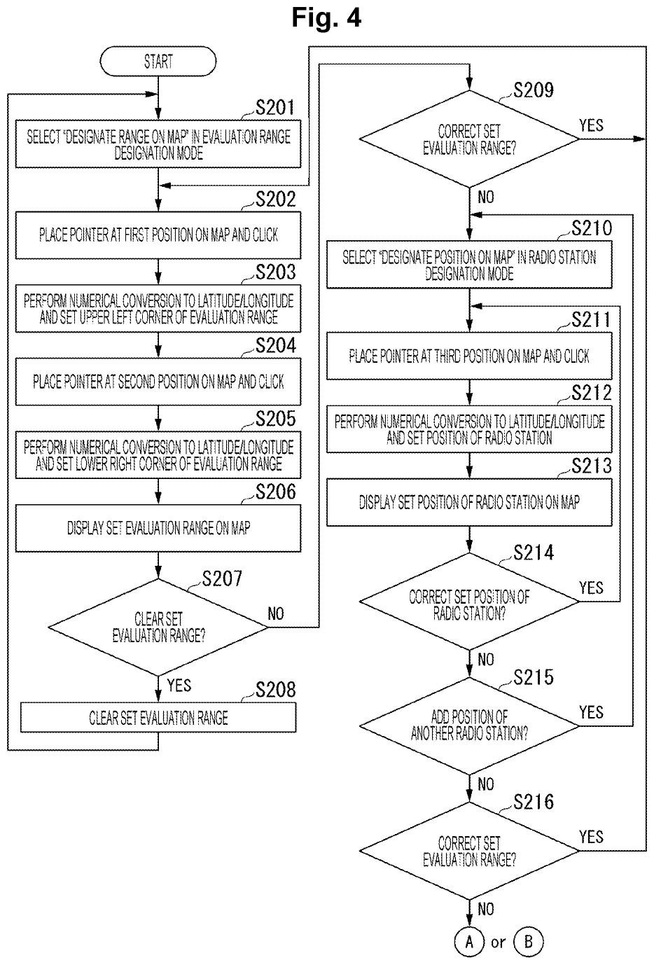

FIG. 4 is a flowchart illustrating details of the operation example of the interference evaluation device 1a according to the first embodiment. That is, FIG. 4 is a flowchart of an operation of executing setting of the evaluation range, and designating, checking, and changing of the position of the radio station on the map. An operation flow for designating the evaluation range and the position of the radio station on the map includes three stages. That is, there are stages of “setting of evaluation range on map”, “display of evaluation range on map and correction and confirmation of set evaluation range”, and “setting and display of position of radio station on map, and correction and addition”.

In the first stage “setting of evaluation range on map”, the evaluation range is set in steps S201 to S205.

In the operation mode for designating the evaluation range, designation of the evaluation range on the map is selected by the user. For example, a “read map” button (not illustrated) is provided in a field for designating an area on the screen for designating the interference evaluation condition. By pressing this button, the evaluation range can be designated on the map (step S201).

The user places the pointer 201 at the position of the pointer 201-1 on the map illustrated in FIG. 2. The user clicks the left button of the operation unit 14 (mouse) (step S202). The position derivation unit 101 numerically converts coordinates designated on the map into latitude and longitude. The latitude and longitude are associated with the position of the upper left corner of an evaluation range 200 (first range).

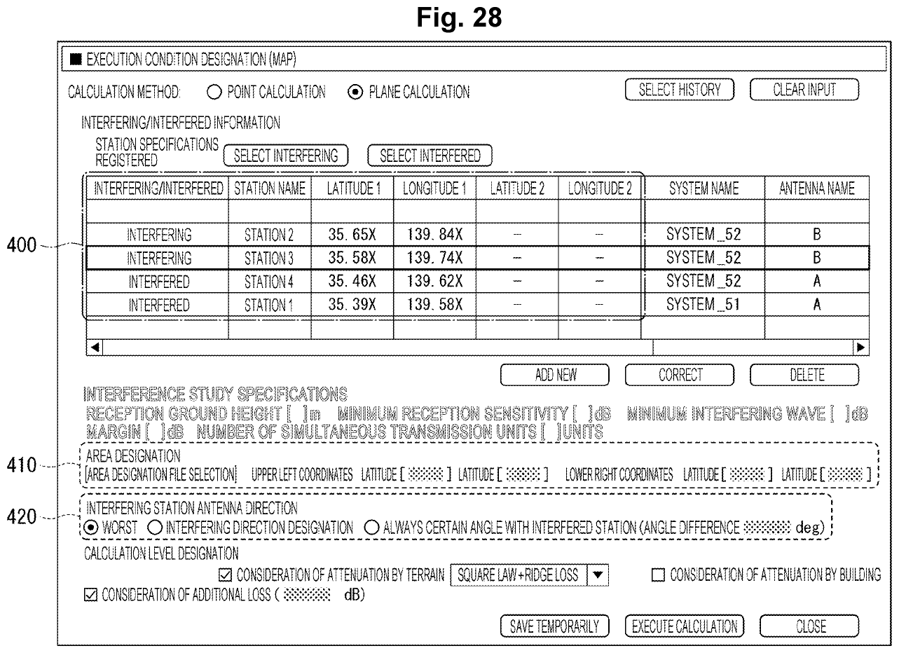

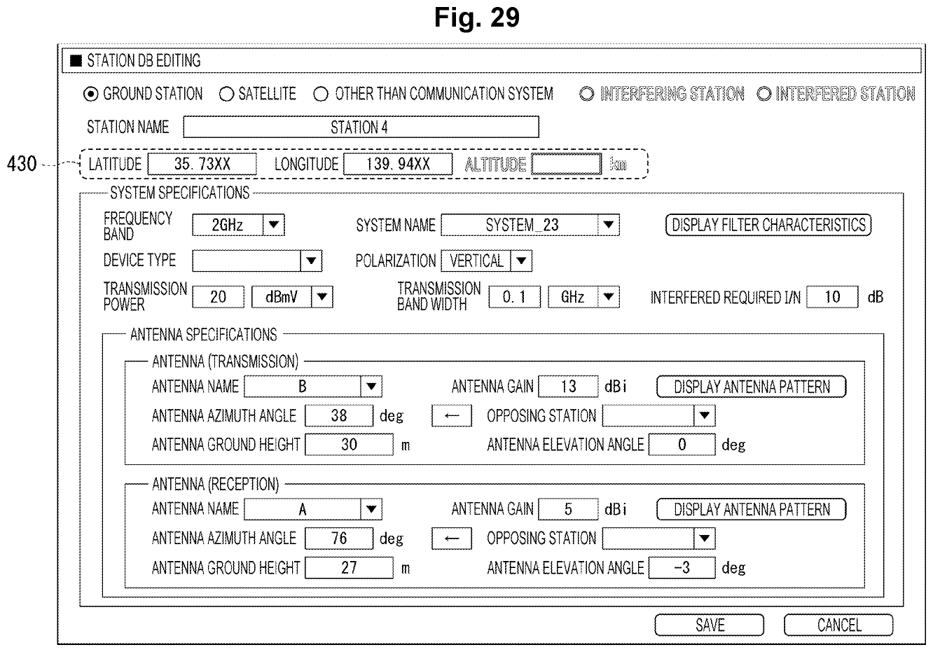

In step S202, numerical conversion is performed into latitude and longitude corresponding to the position of the pointer 201-1 on the map. The numerical values of the latitude and longitude are input to the field of the latitude and longitude of the upper left coordinate of the evaluation range, for example, the area designation setting field 410 of FIG. 28 (step S203).

The user places the pointer 201 at the position of the pointer 201-2 on the map illustrated in FIG. 2. The user clicks the left button of the operation unit 14 (mouse). The latitude and longitude are associated with the position of the lower right corner of the evaluation range 200.

### Step S204

The position derivation unit 101 numerically converts the position of the pointer 201-2 on the map into latitude and longitude. The position derivation unit 101 sets the lower right corner of the evaluation range on the basis of the latitude and longitude. The numerical values of the latitude and longitude are input to the field of the latitude and longitude of the lower right coordinate of the evaluation range, for example, the area designation setting field 410 of FIG. 28 (step S205).

In the second stage “display of evaluation range on map and correction and confirmation of set evaluation range”, the evaluation range is displayed in steps S206 to S209 with respect to the evaluation range set in the first stage. As a result, the user confirms whether or not correction is necessary.

The image processing unit 103a displays, on the display unit 15, the evaluation range 200 set on the map. The evaluation range 200 is displayed as, for example, a rectangle surrounded by a dotted line. Since the upper left corner of the evaluation range 200 is provided with the upside-down L shape and the lower right corner of the evaluation range 200 is provided with the left-right inverted L shape, the set evaluation range 200 is more clearly recognized by the user (step S206).

In a case where the evaluation range 200 displayed on the map is different from the range desired by the user due to a setting error or the like by the user, it is conceivable that the user performs the setting again. Therefore, the evaluation range derivation unit 100 confirms to the user whether to clear the display or the like of the set evaluation range 200 (step S207).

When the display or the like of the set evaluation range 200 is cleared (step S207: YES), the evaluation range derivation unit 100 erases the display or the like of the evaluation range 200 set in the evaluation range (step S208). The interference evaluation device 1a returns the processing to step S201. When the display or the like of the set evaluation range 200 is not cleared (step S207: NO), the evaluation range derivation unit 100 confirms to the user whether or not to correct the evaluation range that has already been set (step S209).

When it is not necessary to correct the evaluation range that has already been set (step S209: NO), the interference evaluation device la advances the processing to step S210 of the third stage.

In the third stage “setting and display of position of radio station on map, and correction and addition of position of radio station”, the user sets the position of the radio station while confirming the evaluation range on the map. The user may correct the position of the evaluation range. The user may add another radio station on the map.

In the third stage, the user designates (selects) the radio station subjected to execution of steps S210 to S216 on the map in a radio station designation mode. On a station DB (station database) editing screen displayed on the display unit 15, for example, a “read map” button is provided in a portion of the latitude and longitude, and altitude for setting the position of the radio station. The user performs an operation of pressing this button to designate the radio station on the map (step S210).

The user places the pointer 201 at the position of the pointer 201-3 on the map, and clicks the left button of the operation unit 14 (mouse). The position derivation unit 101 acquires position information (coordinates) of the pointer 201-3 on the map as the installation position of the interfering station 210 (step S211).

The position derivation unit 101 numerically converts the position information (coordinates) of the pointer 201-3 on the map into latitude and longitude in a real space. The position derivation unit 101 sets the latitude and the longitude as the position where the interfering station 210 (radio station) is installed. The position derivation unit 101 records the latitude and longitude associated with the interfering station 210 in the storage device 12. The position derivation unit 101 inputs the latitude and longitude of the interfering station 210 to the fields of the latitude and longitude on the screen for setting the position of the radio station. In this way, the position where the radio station is installed is set using the map (step S212).

The image processing unit 103a displays the set position of the radio station on the map displayed on the display unit 15. Here, the image processing unit 103a displays the position of the radio station set in steps S211 and S212 on the map. For example, in FIG. 2, the position of the radio station is indicated at the position of the triangle at the position of the interfering station 210. In FIG. 2, the color of the hatched triangle is, for example, red on the screen of the display unit 15. In addition, the outline of the evaluation range 200 indicated by a black dotted line in FIG. 2 is indicated by, for example, a red dotted line on the screen of the display unit 15. As a result, the user can easily understand that the position of the interfering station 210 (radio station) is set within the evaluation range 200 (step S213).

The position derivation unit 101 confirms to the user whether or not to correct the set position of the radio station. The user visually recognizes the display of the radio station indicated on the map and replies whether or not to correct the position using the operation unit 14 (step S214). When the set position of the radio station is corrected (step S214: YES), the position derivation unit 101 returns the processing to step S211. When the set position of the radio station is not corrected (step S214: NO), the position derivation unit 101 advances the processing to step S215.

Whether or not to add the position of another radio station as an evaluation target is confirmed with the user (step S215). When the position of another radio station is added as the evaluation target (step S215: YES), the position derivation unit 101 returns the processing to step S210. When the position of another radio station is not added as the evaluation target (step S215: NO), the position derivation unit 101 advances the processing to step S216.

The evaluation range derivation unit 100 confirms to the user whether or not to correct the set evaluation range. That is, at the stage that the position of the radio station has already been set, the evaluation range derivation unit 100 confirms to the user whether or not the interference evaluation may be executed for the evaluation range that has already been set (step S216). When the set evaluation range is corrected (step S216: YES), the evaluation range derivation unit 100 ends the processing.

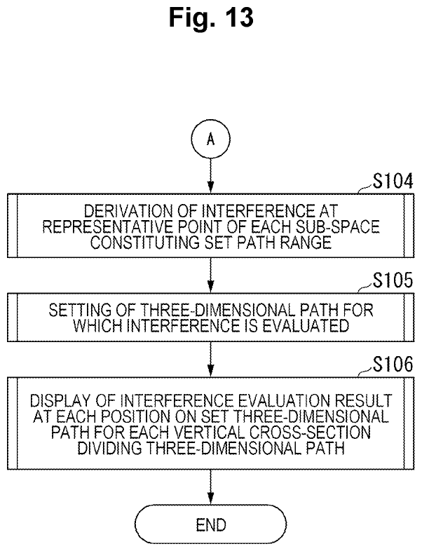

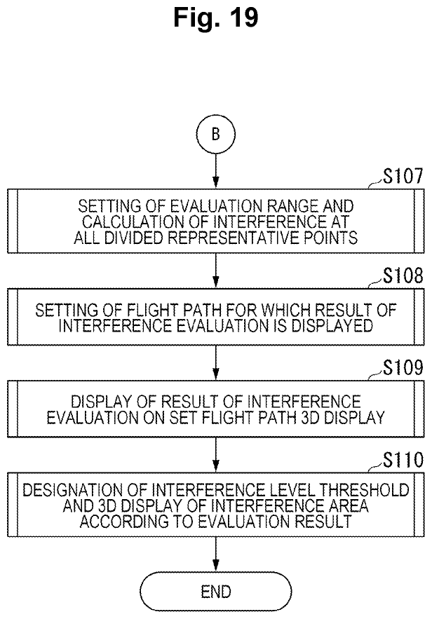

When the set evaluation range is corrected (step S216: YES), the evaluation range derivation unit 100 may advance the processing to connector “A” illustrated in FIG. 13 to be described below. When the set evaluation range is not corrected (step S216: NO), the evaluation range derivation unit 100 may advance the processing to connector “B” illustrated in FIG. 19 to be described below.

As described above, the position derivation unit 101 derives the coordinates of the evaluation range in a real space on the basis of the first range designated using the map, and derives the coordinates of the radio station in a real space on the basis of the position designated using the map. The interference derivation unit 102a derives the interference level of the radio wave transmitted from the radio station for the evaluation range on the basis of the coordinates of the evaluation range and the coordinates of the radio station. The image processing unit 103a displays an image corresponding to the interference level on the display unit.

As a result, it is possible to reduce the time and effort of an operation of designating a radio wave interference evaluation condition.

To more easily and reliably set the evaluation range and the position of a radio station when evaluating the effect of interference of the radio station using interference evaluation software.

When the effect of the interference of the radio station is evaluated, the evaluation range and the position of the radio station can be easily and reliably set by using an interference evaluation support tool to which the aspect of the above-described first example is applied. In particular, since the interference adjustment requires a large number of evaluation studies, it is possible to greatly reduce the time and effort of the above-described setting.

The user can easily designate, confirm, and change the evaluation range and the position of the radio station on the map. Therefore, the user can intuitively and easily understand the relationship between the evaluation range and the position of the radio station. As a result, more appropriate interference evaluation is implemented. In most interference adjustment, it is necessary to consider performing a large number of interference evaluations, but it is possible to greatly reduce the time and effort of the operation.

### Second Embodiment

The second embodiment is different from the first embodiment in that a three-dimensional path is determined in a three-dimensional evaluation range (second range) within the evaluation range 200 (first range). In the second embodiment, the differences from the first embodiment will be mainly described.

As one of use cases of a mobile communication system in local 5th generation (5G) which is being introduced, there is communication to a flying body. A radio station provided in a flying body that receives a radio wave from an interference source (interfering station) may be an interference point. In such a use case, since the interference source or the interference point is present three-dimensionally, it is difficult to predict the interference as compared with a case where the interference source or the interference point is present two-dimensionally. In addition, it is difficult to display a cell and a service area as compared with a case where the interference source or the interference point is present two-dimensionally.

That is, utilization of wireless communication has been diversified in addition to a wireless communication device installed at a fixed position or in addition to a carried, mobile wireless terminal. For example, an unmanned aerial vehicle (flying body) such as a drone (UAV) may be equipped with a radio station. In this case, it is difficult to sufficiently consider an interference countermeasure shared between different wireless systems only by simply indicating the display result of the interference evaluation on the two-dimensional map.

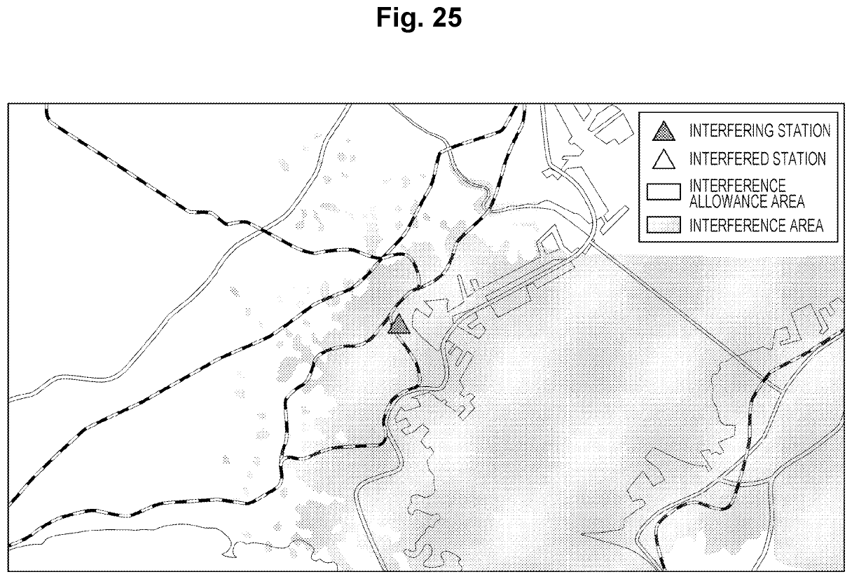

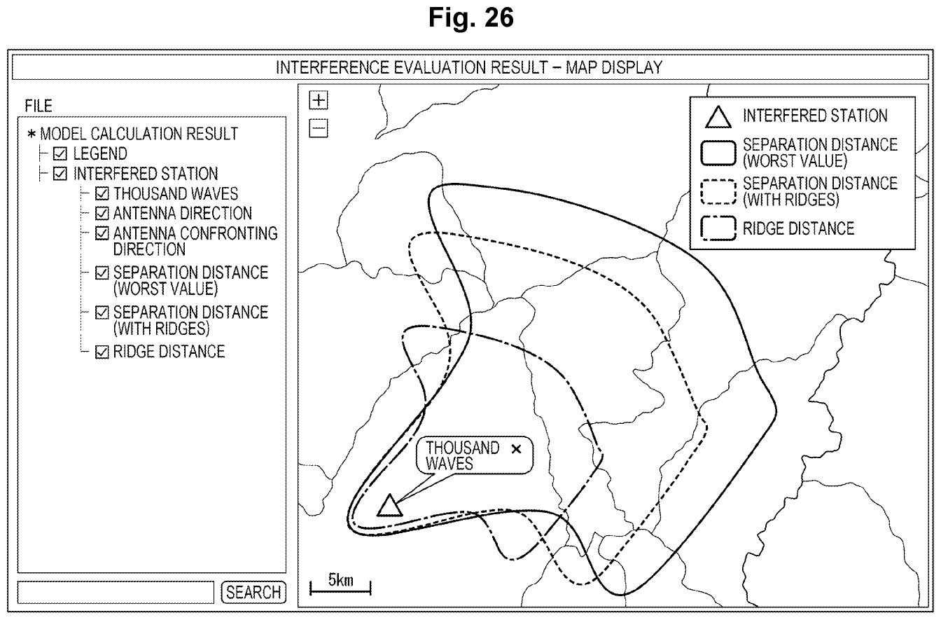

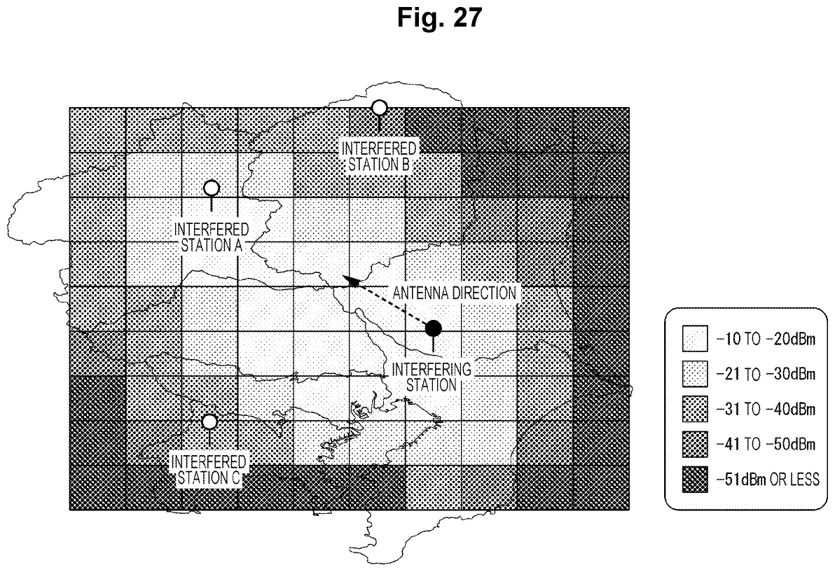

In FIGS. 25, 26, and 27, the difference in radio wave level arriving from the interfering station is indicated by color coding (surrounding with different types of lines, different types of hatching) of the area on the two-dimensional (planar) map. As a result, the user can easily understand the result of the interference evaluation.

These result displays indicated on a two-dimensional map are useful for each interference adjustment for radio base stations whose positions are fixed, vehicles traveling on roads, and wireless terminals (terminals that move two-dimensionally) possessed by people walking on the ground. However, interference adjustment for wireless communication of a flying body (drone, unmanned aerial vehicle (rover), and the like) that moves three-dimensionally may not be useful.

As described above, these result displays indicated on the two-dimensional map are insufficient for checking the evaluation result of the radio wave level at a predetermined height (altitude above a building or above mountain forest in mountain area). That is, since the result of the interference evaluation displayed on the map is the result of the interference evaluation of the plane, the interference status that changes according to the flight altitude of the drone is not expressed in the result of the interference evaluation displayed on the map. Therefore, the user cannot appropriately grasp the interference evaluation of the drone.

After the above-described interference evaluation derivation condition is set, the evaluation result is displayed by executing three stages exemplified below. As a result, sophistication and augmentation of display of the interference evaluation result are achieved.

In the first stage, a three-dimensional evaluation range is set for a flying object (flying body). The evaluation range is divided into a plurality of cuboids as references, and interference calculation is executed at representative points of all cuboids (center point of each cuboid).

In the second stage, a three-dimensional flight path (flight path having wire shape) of the flying object is set. In addition, position information of a plurality of points passing through the flight path designated by the user using the map is converted into numerical values of latitude and longitude. The user inputs the height of each point passing through the flight path to the interference evaluation device using the map. In the third stage, the result of the interference evaluation on the vertical cross-section of the set flight path is displayed.

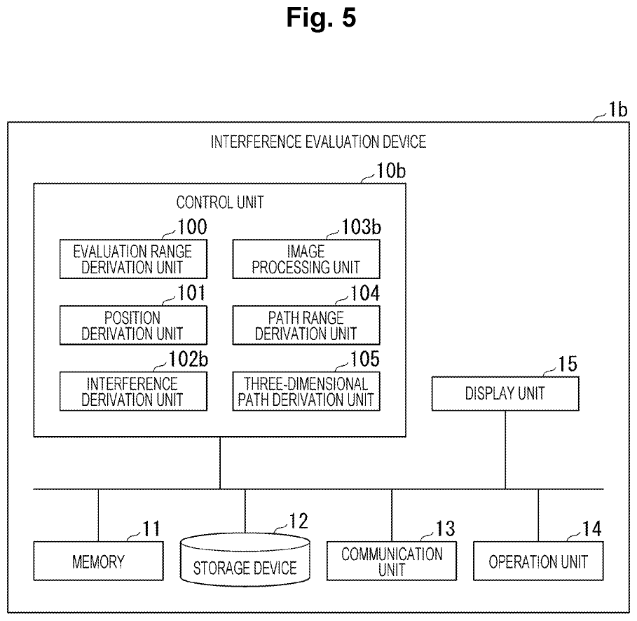

FIG. 5 is a diagram illustrating a configuration example of an interference evaluation device 1b according to the second embodiment. The interference evaluation device 1b is an information processing device that evaluates interference of radio waves. The interference evaluation device 1b includes a control unit 10b, a memory 11, a storage device 12, a communication unit 13, an operation unit 14, and a display unit 15. The control unit 10b includes an evaluation range derivation unit 100, a position derivation unit 101, an interference derivation unit 102b, an image processing unit 103b, a path range derivation unit 104, and a three-dimensional path derivation unit 105.

The path range derivation unit 104 derives a path range (three-dimensional evaluation range) that is a range in which a three-dimensional path is set according to an operation by the user. The three-dimensional path derivation unit 105 derives a three-dimensional flight path (flight path having wire shape) of a flying object (interference point) according to an operation by the user. The three-dimensional path derivation unit 105 converts the position designated on the map as the position of the three-dimensional path into latitude and longitude. The three-dimensional path derivation unit 105 converts the rotation amount designated as the position of the three-dimensional path into altitude. The three-dimensional path derivation unit 105 may convert the position designated on a graph as the position of the three-dimensional path into altitude. The numerical value thus converted is used for interference evaluation as the position of the three-dimensional path.

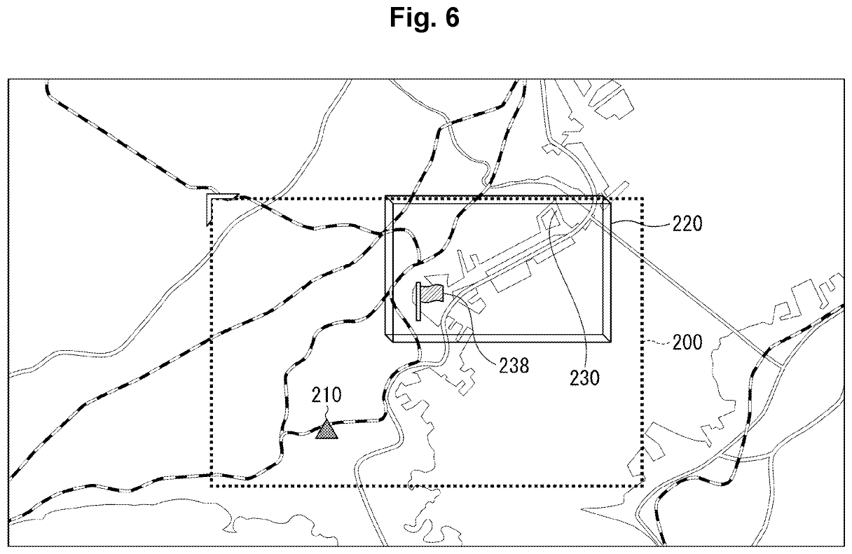

FIG. 6 is a diagram illustrating an example of a designation screen for an evaluation range (first range) and a path range (second range) according to the second embodiment. The evaluation range 200 is set on the map at the same place (range) as in the example of FIG. 2. The evaluation range derivation unit 100 sets a path range 220 in the evaluation range 200 by a user operation similar to the user operation of setting the evaluation range 200 on the map.

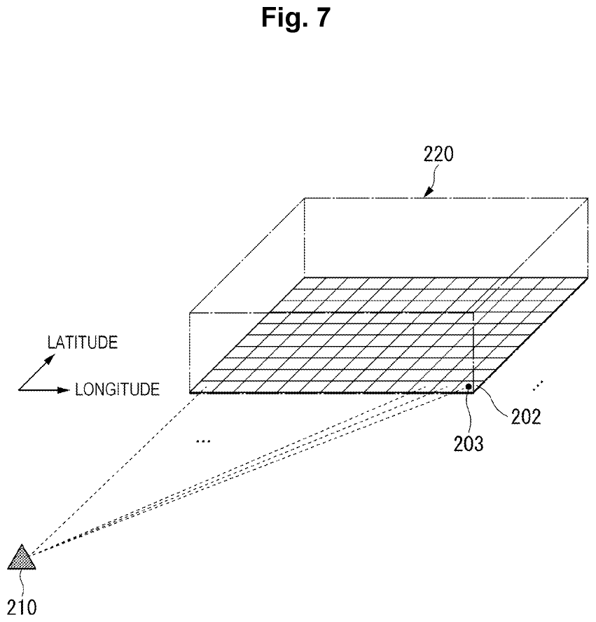

FIG. 7 is a diagram illustrating an example of interference evaluation of a two-dimensional path range (planar evaluation range) according to the second embodiment. In consideration of latitude and longitude, a two-dimensional evaluation range is defined. The path range 220 includes a path on the ground determined by projection of a three-dimensional path range of a flying object (interference point). The ground surface of the path range 220 includes sub-spaces 202 (rectangle) divided into a longitude direction and a latitude direction. The interference derivation unit 102b derives an evaluation result of interference evaluation on the ground surface of the path range 220 between the interfering station 210 and each representative point 203 (center point of rectangle). Note that the interference derivation unit 102b may derive the evaluation result of the interference evaluation on the ground surface similarly for the planar evaluation range 200.

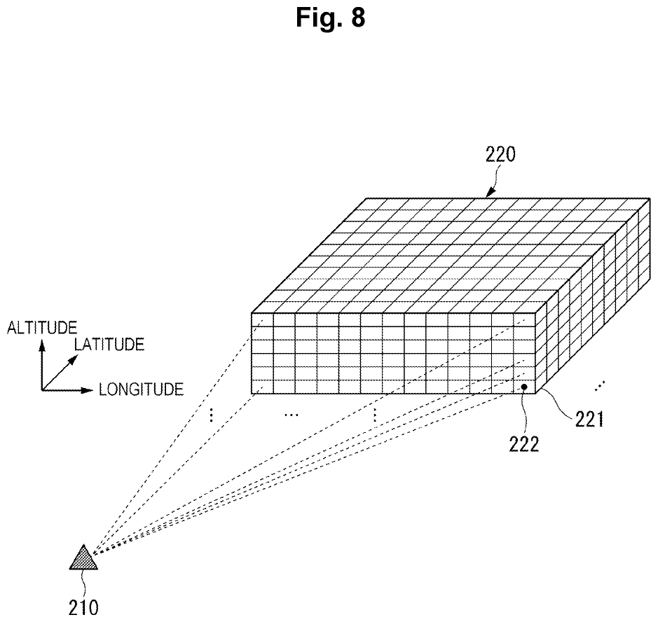

FIG. 8 is a diagram illustrating an example of interference evaluation of a three-dimensional path range (three-dimensional evaluation range) according to the second embodiment. A three-dimensional path range is defined in consideration of latitude, longitude, and altitude. The path range 220 includes a three-dimensional flight path of a flying object (interference point). The path range 220 includes sub-spaces 221 (cuboid) divided into a longitude direction, a latitude direction, and an altitude direction. The interference derivation unit 102b derives an evaluation result of interference evaluation between the interfering station 210 and each representative point 222 (center point of cuboid).

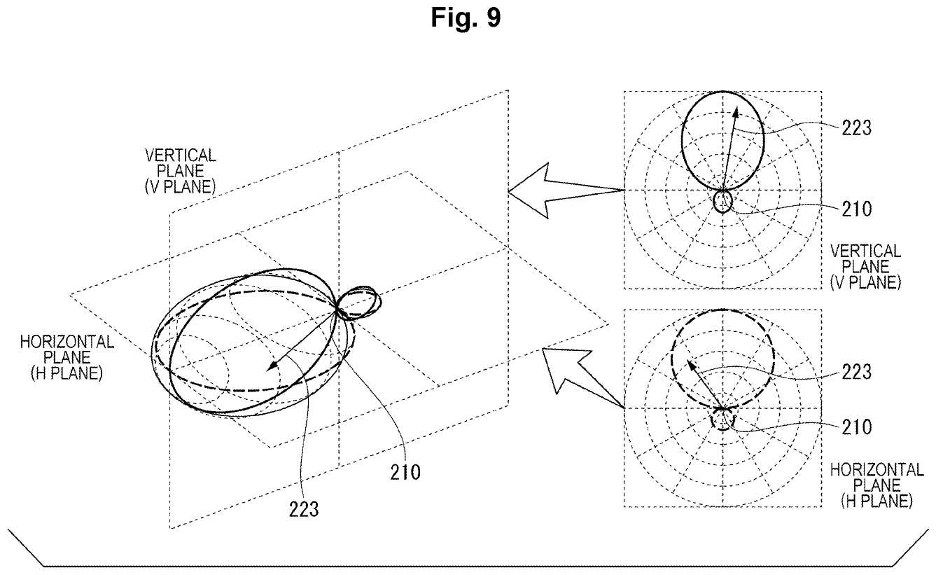

FIG. 9 is a diagram illustrating an example of an antenna pattern according to the second embodiment. In the interference evaluation between the interfering station 210 and the representative point 222, a three-dimensional antenna pattern of the interfering station 210 is considered.

The upper right graph in FIG. 9 indicates an antenna pattern of a vertical cross-section (V plane). The lower right graph indicates an antenna pattern of a horizontal cross-section (H plane). The graph on the left side indicates a combination of the antenna pattern of the vertical cross-section (V plane) and the antenna pattern of the horizontal cross-section (H plane). A representative point direction vector 223 indicates a direction vector from the interfering station 210 to the representative point 222. The vector size of the representative point direction vector 223 indicates gain. When the representative point direction vector 223 is directed in a front direction (peak direction) of the interfering station 210, the vector size of the representative point direction vector 223 indicates maximum gain. The interference evaluation is executed in consideration of a decrease in interference level using the representative point direction vector 223.

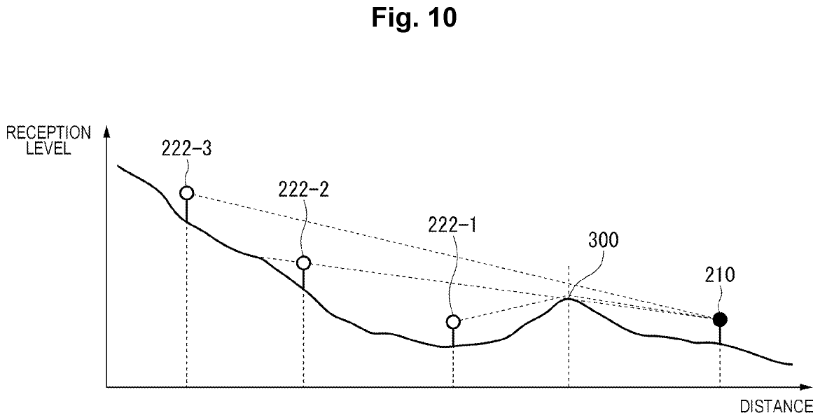

FIG. 10 is a diagram illustrating an example of terrain data according to the second embodiment. Three-dimensional terrain data may be taken into consideration in the interference evaluation. The storage device 12 stores, in advance, vertical cross-sectional data of the terrain between the interfering station 210 and the interfered station (representative point 222). In FIG. 10, depending on the position of the representative point 222, there are a case where there is a line of sight of radio waves (representative point 222-2, representative point 222-3) and a case where there is no line of sight of radio waves (representative point 222-1). When there is no line of sight, interference evaluation is executed in consideration of loss due to shielding terrain (ridge 300).

In the interference evaluation in wireless communication, in a case where a wireless system in which radio stations whose positions are fixed use low frequency (<several GHz) is a target, the accuracy of the interference evaluation is increased to some extent by considering the antenna pattern of the interfering station 210 and the terrain data.

However, there is a case where a company or a local government does not rely on a local 5G communication company (carrier), and the company or the local government constructs a unique 5G network that can be used in a limited range (for example, in own building, in own land). In this case, a higher frequency (≥several GHz) needs to be considered in interference evaluation of wireless communication. Therefore, position data and shape data of an artifact such as a building may be further considered for interference evaluation.

For example, the interference evaluation in Japan may be executed using terrain data provided by the Geospatial Information Authority of Japan and a three-dimensional map (digital map including building height and building shape information) provided by a map vendor. The interference evaluation may be executed in consideration of the situation of the building present between the representative point 222 of the sub-space 221 that divides the evaluation range 200 in which the interfered station is assumed to be installed and the position of the interfering station 210. As a result, it is possible to obtain an evaluation result of necessary accuracy even for wireless communication of high frequency.

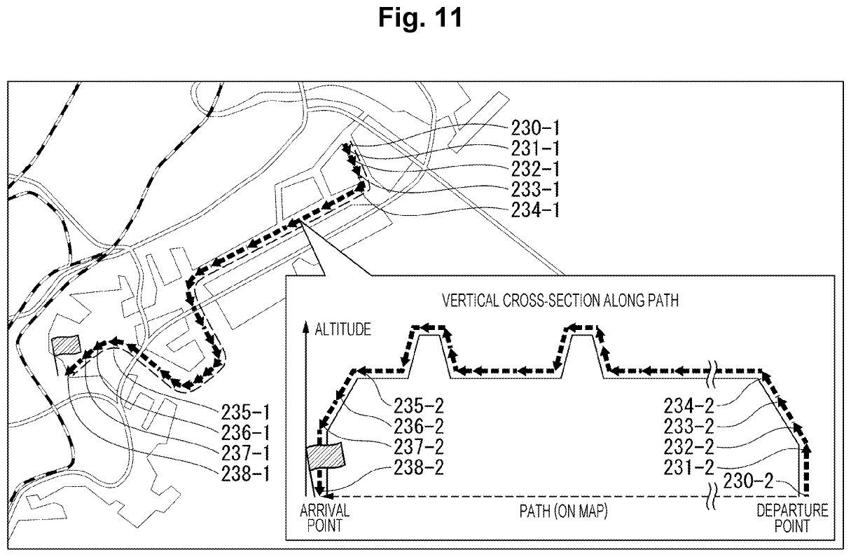

FIG. 11 is a diagram illustrating a setting example of a three-dimensional path having a wire shape according to the second embodiment. FIG. 11 expresses an enlarged map of a part (a range including a three-dimensional path) of the map illustrated in FIG. 2. In addition, the interference level for each vertical cross-section dividing the three-dimensional path is expressed along the path projected on the map (path on the map).

Regarding the height (altitude) of the flight path of a flying body such as a drone, the highest point of the altitude at which the drone flies and the pitch (for example, unit height) from the ground to the highest point are separately designated. For each representative point of the sub-space constituting the designated evaluation range, an evaluation result of interference such as a reception level of radio waves is derived.

If the evaluation result is displayed on a planar map, the effect of interference of a flying body such as a drone becomes unclear. Therefore, the user sets the flight path of the drone using the planar map and the vertical direction graph. In the setting of the three-dimensional path having a wire shape, the user moves the pointer 201 of the operation unit 14 (mouse) on the map or the graph, similarly to the operation for setting the evaluation range 200 and the position of the interfering station 210. As a result, the user operates the operation unit 14 to designate a plurality of three-dimensional path passing points so as to connect a departure point 230-1 to an arrival point 238-1. The plurality of three-dimensional path passing points is, for example, each point from a three-dimensional path passing point 231-1 to a three-dimensional path passing point 237-1. In FIG. 11, drawing of other three-dimensional path passing points in the three-dimensional path is omitted. The altitude (ground height) of each three-dimensional path passing point is additionally input by the user. The flight path is expressed as a polygonal line connecting contacts between three-dimensional path passing points. The position of a portion at which the line is bent in the polygonal line is the position of the three-dimensional path passing point (designated point).

For example, the latitude and longitude corresponding to the position of the three-dimensional path passing point are derived by the user designating the position on the planar map using the pointer 201. With respect to the position of the pointer 201, the altitude of the three-dimensional path passing point is input to the three-dimensional path derivation unit 105 according to the rotation amount (rotation speed, angle) of the wheel switch of the operation unit 14 (mouse).

The user inputs the latitude and longitude to the position derivation unit 101 using the pointer 201 moving on the map. The user can quickly and easily set the three-dimensional path of the drone in the interference evaluation device by sequentially repeating the input of the altitude of the three-dimensional path passing point by the wheel operation of the operation unit 14 (mouse).

The horizontal axis in the “vertical cross-section along path” illustrated in FIG. 11 indicates a path on the map. The vertical axis indicates flight altitude. “Vertical cross-section along path” displays a vertical cross-section of a three-dimensional flight path (flight path having wire shape) along the path. The rotation amount (rotation speed, angle) of the wheel switch of the operation unit 14 (mouse) is input and set in a database as an altitude value at each designated point (three-dimensional path passing point). The user can easily input and set the position (latitude and longitude) and the altitude of the designated point of the flight path.

On the horizontal axis indicating the flight path from a departure point 230-2 to an arrival point 238-2, the path bent along the map is straightly extended. Accordingly, the horizontal axis of the “vertical cross-section along path” indicates a horizontal flight distance from a departure point of a flying body such as a drone. In addition, the horizontal flight distance from the departure point to the arrival point of the flying body indicates the total flight distance of the flying body. In addition, the vertical axis indicates the sea level height (altitude) of the three-dimensional path having a wire shape. That is, the vertical axis indicates the level of the altitude of the flight path.

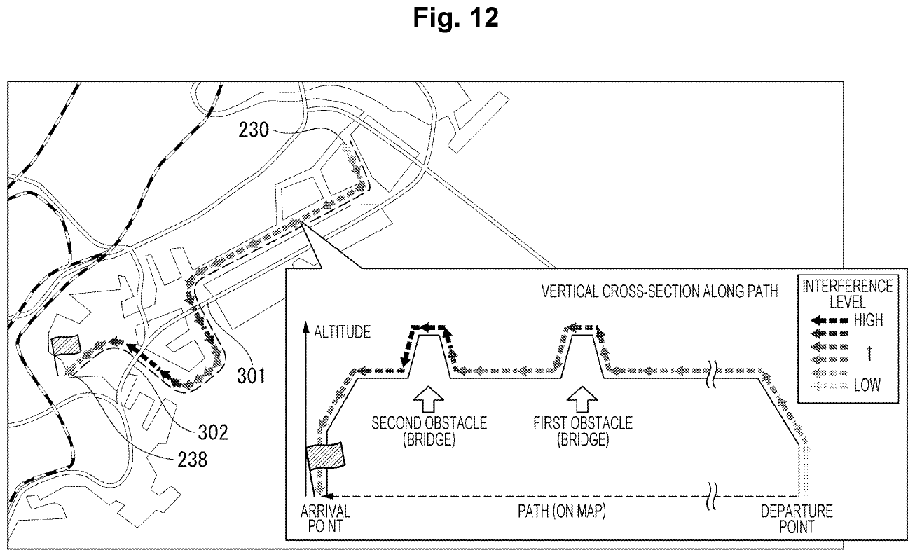

FIG. 12 is a diagram illustrating an example of a screen of an interference evaluation result according to the second embodiment. FIG. 12 expresses an enlarged map of a part (a range including a three-dimensional path) of the map illustrated in FIG. 2. In addition, the interference level for each vertical cross-section dividing the three-dimensional path is expressed along the path projected on the map (path on the map). In “vertical cross-section along path”, the color of each arrow sequentially connecting a departure point 230 to an arrival point 238 of the three-dimensional path (route of flying body) is used to indicate the interference level for each arrow. Here, on the screen of the display unit 15, they are distinguished by color, but in FIG. 12, they are distinguished by shading. For example, the interference level is the highest in a path section (vertical cross-sectional section) in which a red arrow (black arrow in FIG. 12) is indicated on the screen of the display unit 15. On the screen of the display unit 15, the interference level decreases in the order of red, orange, yellow, yellowish green, light blue, and dark blue (in FIG. 12, in the order of black to dark gray and light gray).

As illustrated in FIG. 12, the interference level changes according to the latitude, longitude, and altitude of the three-dimensional path from the departure point 230 to the arrival point 238. By displaying the interference level using the arrows on the map, the user can grasp the interference level of each three-dimensional path passing point constituting the three-dimensional path of the flying body at a glance. For example, in the three-dimensional path of the flying body, the closer the flying body approaches the arrival point 238, the higher the interference level of the flying body (interfered station). This is because the interfering station 210 is disposed at a position beyond the arrival point 238 of the three-dimensional path of the flying body.

In the result of the interference evaluation, it is assumed that the interference level varies depending on the altitude of the flight path. As illustrated in FIG. 6, the position of the interfering station 210 is at a position angle obtained by further extending the flight path from the arrival point 238. Therefore, in the entire flight path, it is expected that the interference level becomes higher as the three-dimensional path passing point is closer to the arrival point 238 among the plurality of three-dimensional path passing points.

In the middle of the three-dimensional path, there are a first obstacle (bridge) and a second obstacle (bridge). A flying body (not illustrated) flies over the first obstacle 301 (bridge) and the second obstacle 302 (bridge). In the evaluation result for each vertical cross-section along the three-dimensional path (flight path), the difference in interference level depending on the altitude is indicated by the difference in color of the arrow. The flying body moves from the departure point 230 along the three-dimensional path at a normal predetermined altitude. Before the arrival point 238, the flying body increases the altitude higher than the normal predetermined altitude to avoid the first obstacle 301 and the second obstacle 302.

Since the altitude of the three-dimensional path is high above the first obstacle (bridge) and the second obstacle (bridge), the interference level is high as compared with other sections of the three-dimensional path. In this manner, the user can easily grasp the interference level by checking the interference level indicated by the vertical cross-section along path.

Next, an operation example of the interference evaluation device 1b will be described.

FIG. 13 is a flowchart illustrating an operation example of the interference evaluation device 1b according to the second embodiment. Following step S103 of FIG. 3, the evaluation range derivation unit 100 sets a path range 220 in the evaluation range 200 by a user operation similar to the user operation of setting the evaluation range 200 on the map. The interference derivation unit 102b derives an interference level for the representative point 222 of a sub-space 221 constituting the path range 220 set using the map. The interference derivation unit 102b may derive an interference level for the representative point 203 of a sub-space 202 constituting the path range 220 set using the map (step S104).

The interference evaluation needs to be executed for the three-dimensional path on which a flying body (such as a drone) that can be an interfered station flies. Therefore, a three-dimensional path to be subjected to the interference evaluation is set (step S105). The display unit 15 displays the result of the interference evaluation for each vertical cross-section dividing the set three-dimensional path (step S106).

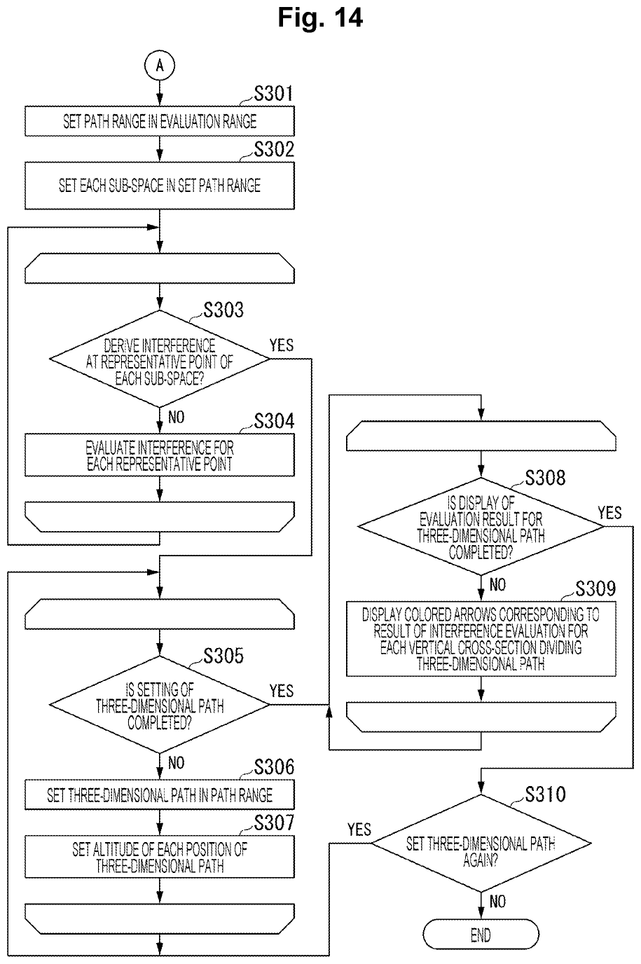

FIG. 14 is a flowchart illustrating details of the operation example of the interference evaluation device 1b according to the second embodiment. The flowchart of FIG. 14 includes three stages. In the first stage, the setting of the path range 220 (three-dimensional evaluation range) and the derivation of the interference level at the representative points of all the sub-spaces are executed. In the second stage, a three-dimensional path to be subjected to the interference evaluation is set. In the third stage, the result of the interference evaluation is displayed for each vertical cross-section dividing the set three-dimensional path.

In the first stage, following step S103 of FIG. 3, the path range 220 (three-dimensional evaluation range) is newly set using the map. When a planar map is used, the latitude and longitude corresponding to the upper left corner of the path range 220 are set as described in the first embodiment. The latitude and longitude corresponding to the lower right corner of the path range 220 are set. In addition, the path range 220 (three-dimensional evaluation range) is set according to the highest point of the three-dimensional path of the flying body (step S301).

The path range derivation unit 104 divides the designated path range 220 by sub-spaces (cuboid). The size of the sub-space 202 on the horizontal plane may be determined in advance on the basis of the size (latitude and longitude) of the path range 220 (three-dimensional evaluation range) and the reference size (for example, in units of 200 m, 50 m, or 10 m). The path range 220 may be divided by, for example, “100×100” sub-spaces 202 (meshes).

The height direction of the path range 220 may be divided by the sub-spaces 221 by dividing the path range 220 by a predetermined altitude width (for example, 10 m, 5 m, 2 m) between the highest point (for example, a height of 300 m, 150 m, 50 m, or the like) of the three-dimensional path and the ground 0 m. The portion between the highest point and the ground may be divided by a predetermined number of height intervals (for example, 30, 10, 5, or the like). In this manner, the three-dimensional path range 220 is divided into the sub-spaces 202 so as to divide the path range 220 in a three-axis direction (step S302).

The interference derivation unit 102b determines whether interference has been derived for the representative points 222 of all the sub-spaces 221 in the path range 220. The representative point 222 is, for example, a center point of the sub-space 221 (cuboid) (step S303). When interference is derived for the representative points 222 of all the sub-spaces 221 of the path range 220 (step S303: YES), the interference derivation unit 102b advances the processing to step S305. When interference is not derived for any of the representative points 222 of the sub-spaces 221 of the path range 220 (step S303: NO), the interference derivation unit 102b advances the processing to step S304.

The interference derivation unit 102b derives an interference level for each representative point 222. In deriving the interference level, a distance between the interfering station 210 and the representative point 222 is considered.

In addition, a high portion present in the terrain between the interfering station 210 and the representative point 222 is considered as the ridge 300 (step S304).

In the second stage, the interference derivation unit 102b determines whether or not the three-dimensional path is set from the departure point 230 to the arrival point 238 (step S305). When the three-dimensional path is set from the departure point 230 to the arrival point 238 (step S305: YES), the interference derivation unit 102b advances the processing to step S308. When the three-dimensional path is set halfway from the departure point 230 to the arrival point 238 (step S305: NO), the interference derivation unit 102b advances the processing to step S306.

The user sets a three-dimensional path of a flying body equipped with a radio station for wireless communication using a map. The user determines the position (latitude and longitude) of the three-dimensional path passing point (point) on the map in order from the departure point 230. The three-dimensional path derivation unit 105 connects the previously set three-dimensional path passing point and the currently set three-dimensional path passing point with a straight line segment (arrow). In the setting of the three-dimensional path passing point, the operation unit 14 (mouse) may be utilized (step S306) similarly to the operation method described in the first embodiment.

The three-dimensional path derivation unit 105 determines the altitude of each three-dimensional path passing point of the three-dimensional path according to the operation by the user. Here, the three-dimensional path derivation unit 105 determines the ground height of the three-dimensional path passing point set in the immediately preceding step S306 (step S307). When the setting of the altitude is completed, the three-dimensional path derivation unit 105 returns the processing to step S305.

In the third stage, the image processing unit 103b determines whether or not the display of the interference level has been completed for all the three-dimensional path passing points (vertical cross-sections) from the departure point 230 to the arrival point 238 of the three-dimensional path (step S308). When the display of the interference levels has been completed for all the three-dimensional path passing points (step S308: YES), the image processing unit 103b advances the processing to step S310. When the display of the interference level has not been completed for any of the three-dimensional path passing points (step S308: NO), the image processing unit 103b displays colored arrows corresponding to the result of the interference evaluation on the display unit 15 for each vertical cross-section dividing the three-dimensional path (step S309). After the colored arrow is displayed, the image processing unit 103b returns the processing to step S308 again.

The image processing unit 103b confirms to the user whether or not to set the three-dimensional path again (step S310). When it is necessary to set the three-dimensional path again (step S310: YES), the image processing unit 103b returns the processing to step S305. When it is not necessary to set the three-dimensional path again (step S310: NO), the interference evaluation device 1b ends the processing of the flowchart illustrated in FIG. 14.

As described above, the path range derivation unit 104 derives the coordinates of the path range 220 that can include a three-dimensional path in a real space on the basis of the path range 220 (second range) designated within the evaluation range 200 (first range) using the map. The three-dimensional path derivation unit 105 derives coordinates (coordinates of departure point 230, coordinates of each three-dimensional path passing point, coordinates of arrival point 238) of the three-dimensional path on the basis of the path designated using the map (the path from the departure point 230 to the arrival point 238). The interference derivation unit 102b derives an interference level for the path range 220. The image processing unit 103b displays an image corresponding to the interference level in the three-dimensional path on the display unit 15.

As a result, since a three-dimensional interference power heat map is visualized, it is possible to provide the user with the result of the interference evaluation in a more easily understandable manner while reducing the time and effort of the operation of designating the radio wave interference evaluation condition.

Since the vertical cross-section along the flight path of an unmanned aerial object is applied to a radio station whose installation position is not fixed and a portable radio station such as a mobile terminal, the user can more easily grasp the result of the interference evaluation in the radio station mounted on an unmanned aerial object in the sky. In addition, it is possible to provide the user with an assistance tool for making it easy for the user to select a three-dimensional path that reduces or alleviates the effect of interference in the flying body.

### Modification of Second Embodiment

In a modification of the second embodiment, a difference from the second embodiment is that an interference level is displayed as a bird's eye view using a plurality of colored arrows along a three-dimensional path having a wire shape. In the modification of the second embodiment, the differences from the second embodiment will be mainly described.

In the second embodiment, for a three-dimensional path that is bent on a horizontal plane (the ground) when projected on the horizontal plane, the three-dimensional path from the departure point 230 to the arrival point 238 is extended straight, and the vertical cross-section of the three-dimensional path is displayed as in “vertical cross-section along path” illustrated in FIG. 12. The three-dimensional path may be displayed in a bent wire shape using a three-dimensional map (bird's eye view). A colored arrow according to the interference level may be given to the bent three-dimensional path having a wire shape for each vertical cross-section dividing the three-dimensional path.

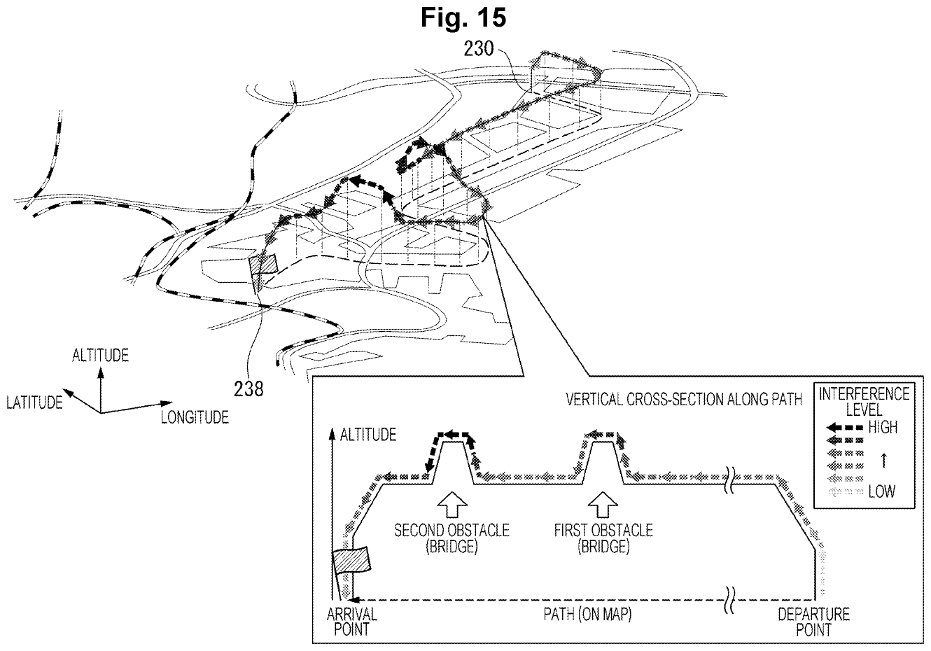

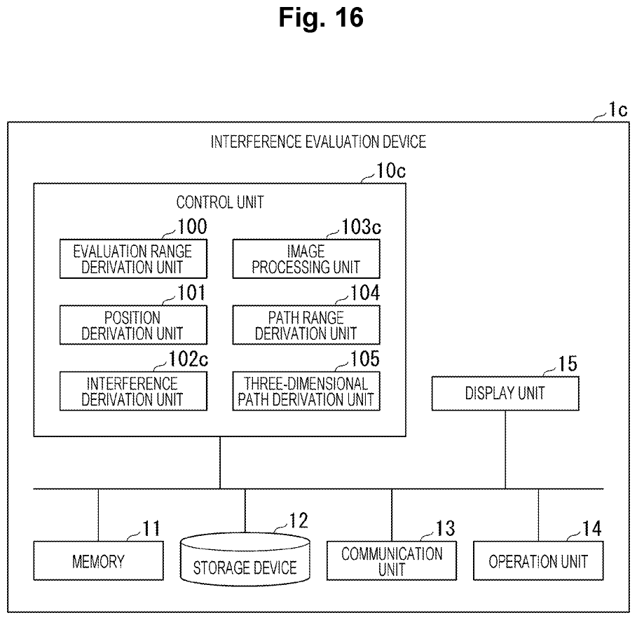

FIG. 15 is a diagram illustrating an example of a screen (bird's eye view map) of an interference evaluation result according to the modification of the second embodiment. In FIG. 15, an interference level is displayed as a bird's eye view using a plurality of colored arrows along a three-dimensional path having a wire shape. For example, the interference level and the bird's eye view for each vertical cross-section along the three-dimensional path are displayed on the same screen. In the bird's eye view, a state in which the interference level changes according to the latitude, longitude, and altitude is drawn using colored arrows. As a result, the user can easily grasp at which part on the three-dimensional path the position at which the interference level is high or low is located.

Note that the degree of coloring of the two-dimensional map corresponding to the background (underlay) of the bird's eye view may be suppressed to a predetermined level so that the path on the ground, the three-dimensional path, and the colored arrows can be more easily seen. The viewpoint may be rotated using the respective directional axes of latitude, longitude, and altitude (x-axis, y-axis, z-axis). In particular, in a complex case (for example, the case that three-dimensional paths intersect), the three-dimensional paths may be rotated according to the rotation of the three-dimensional map. That is, the viewpoint to the three-dimensional path may have a degree of freedom in a three-dimensional direction.

As described above, an interference level is displayed as a bird's eye view using a plurality of colored arrows along a three-dimensional path having a wire shape. As a result, it is possible to more easily understand the evaluation result of the interference using a three-dimensional image (three-dimensional map) (three-dimensional bird's eye view) including the three-dimensional path while reducing the time and effort of the operation of designating the wave interference evaluation condition.

### Third Embodiment

The third embodiment is different from the first embodiment in that an interference area in which an interference level is equal to or higher than a threshold is colored in a three-dimensionally displayed path range (three-dimensional evaluation range). In the third embodiment, the differences from the first embodiment will be mainly described.

It may be difficult to change a three-dimensional path (flight path) of a flying body moving in the horizontal direction and the vertical direction to a path with less effect of interference. In the second embodiment, the result of the interference evaluation is displayed from the viewpoint that the user confirms in detail the degree of the interference level in a predetermined three-dimensional path.

On the other hand, in the third embodiment, the display of the result of the interference evaluation is three-dimensional. That is, the interference area by the interfering station is displayed as a three-dimensional image. Since the interference area is displayed as a three-dimensional image (three-dimensional interference level distribution diagram), the user can easily change the three-dimensional path so that the three-dimensional path does not pass through the interference area.

After the interference evaluation condition is set, the result of the interference area (interference evaluation) by the interfering station for the three-dimensional path is displayed according to the four stages described below.

In the first stage, a three-dimensional path range 220 is determined for the flying body. The path range 220 is divided by sub-spaces (cuboid) serving as references. Interference is derived for representative points of all the sub-spaces (center point of each cuboid).

In the second stage, the user operates the operation unit 14 to designate a plurality of three-dimensional path passing points so as to connect a departure point 230 to an arrival point 238. The three-dimensional path derivation unit 105 derives a three-dimensional flight path (flight path having wire shape) of a flying object (interference point) according to an operation by the user. The three-dimensional path derivation unit 105 converts the position designated on the map as the position of the three-dimensional path into latitude and longitude. The three-dimensional path derivation unit 105 converts the rotation amount designated as the position of the three-dimensional path into altitude. The three-dimensional path derivation unit 105 may convert the position designated on a graph as the position of the three-dimensional path into altitude. The numerical value thus converted is used for interference evaluation as the position of the three-dimensional path. In addition, the result of the interference evaluation (interference area) is displayed three-dimensionally in an easily understandable manner.

In the third stage, colored arrows are displayed in colors corresponding to the result of the interference evaluation (interference level) for each three-dimensional path passing point of the three-dimensional path displayed three-dimensionally.

In the fourth stage, the user may designate the threshold of the interference level in the interference area using the operation unit 14. The image processing unit colors an interference area in which the interference level is equal to or higher than the threshold in the three-dimensionally displayed path range 220 (three-dimensional evaluation range). The image processing unit transparentizes an interference area in which the interference level is less than the threshold in the three-dimensionally displayed path range 220.

FIG. 16 is a diagram illustrating a configuration example of an interference evaluation device 1c according to the third embodiment. The interference evaluation device 1c is an information processing device that evaluates interference of radio waves. The interference evaluation device 1c includes a control unit 10c, a memory 11, a storage device 12, a communication unit 13, an operation unit 14, and a display unit 15. The control unit 10c includes an evaluation range derivation unit 100, a position derivation unit 101, an interference derivation unit 102c, an image processing unit 103c, a path range derivation unit 104, and a three-dimensional path derivation unit 105.

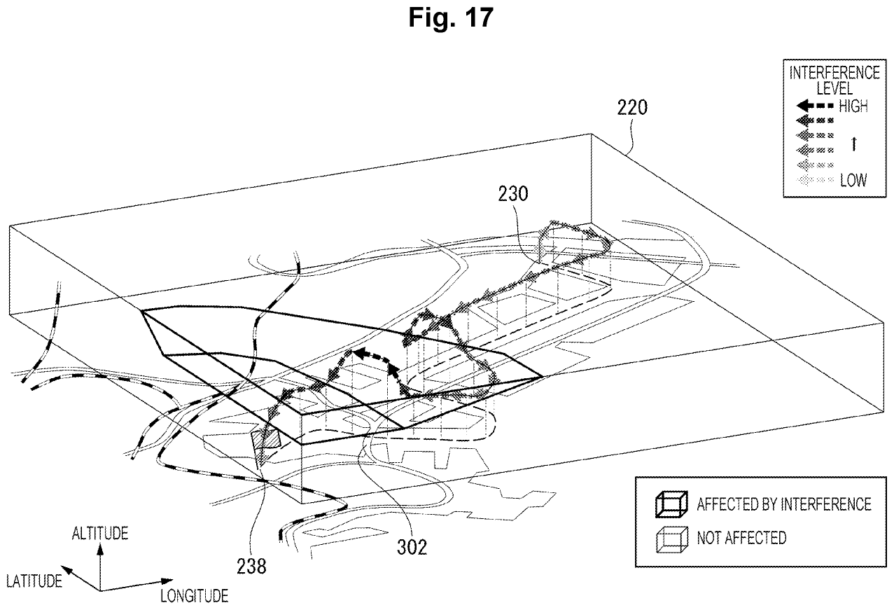

FIG. 17 is a diagram illustrating a first example of a screen of an interference evaluation result of a three-dimensional path according to the third embodiment. In FIG. 17, the image processing unit 103c three-dimensionally displays, on the display unit 15, the interference area having the highest interference level and the three-dimensional path of the flying body equipped with an interfered station. The image processing unit 103c three-dimensionally displays, on the display unit 15, an area where the effect of the interference is equal to or greater than the threshold using, for example, a red cuboid group (in FIG. 17, a three-dimensional shape of a thick solid line) on the screen of the display unit 15. The image processing unit 103c three-dimensionally displays, on the display unit 15, an area where the effect of the interference is less than the threshold using, for example, a transparent cuboid group. As a result, the user can easily confirm (grasp) the area where the effect of the interference is equal to or greater than the threshold.

The user changes the three-dimensional path so that the three-dimensional path does not pass through the area where the effect of the interference is equal to or greater than the threshold while viewing the three-dimensionally displayed interference area and three-dimensional path. For example, the user can easily determine, on the basis of the three-dimensionally displayed interference area and three-dimensional path, that the three-dimensional path may pass below the second obstacle 302 in order for the flying body to avoid the second obstacle 302 and the interference area.

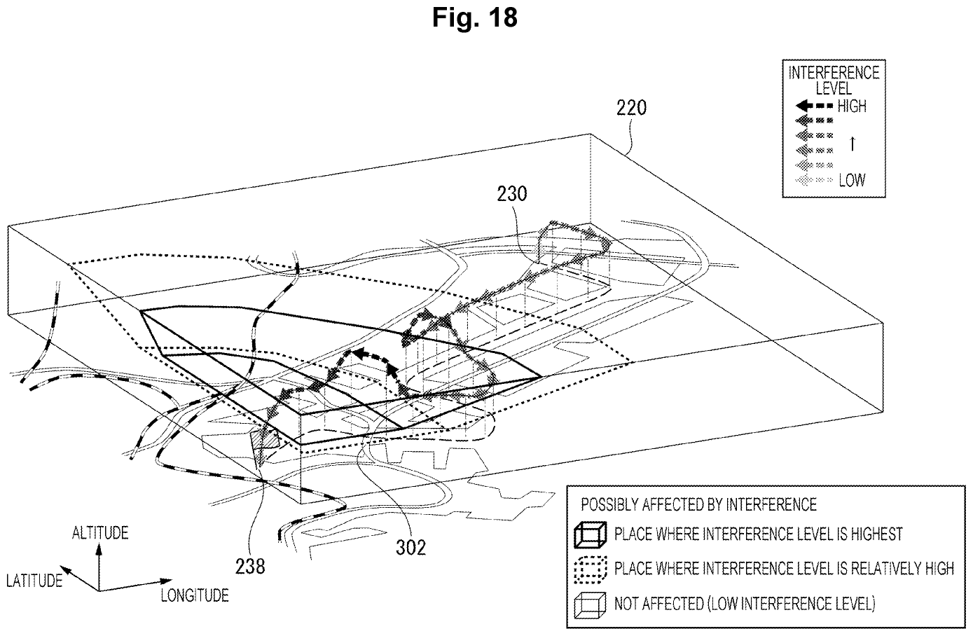

FIG. 18 is a diagram illustrating a second example of a screen of an interference evaluation result of a three-dimensional path according to the third embodiment. In FIG. 18, the image processing unit 103c three-dimensionally displays, on the display unit 15, an interference area having the highest interference level, an interference area having a relatively high interference level (an interference area in which an interfered station is likely to be affected by interference), and a three-dimensional path of a flying body equipped with an interfered station.

The image processing unit 103c three-dimensionally displays, on the display unit 15, the interference area having the highest interference level using, for example, a red cuboid group (similarly to FIG. 17, in FIG. 18, a three-dimensional shape of a thick solid line). The image processing unit 103c three-dimensionally displays, on the display unit 15, the interference area having a relatively high interference level using, for example, an orange cuboid group (in FIG. 18, a three-dimensional shape of a dotted line). The image processing unit 103c three-dimensionally displays, on the display unit 15, an area where the effect of the interference is less than the threshold using, for example, a transparent cuboid group. As a result, the user can easily confirm (grasp) not only the interference area in which the effect of the interference is equal to or greater than the threshold but also the interference area in which the interference level is relatively high.

Note that the image processing unit 103c may thee-dimensionally displays, on the display unit 15, the interference area having the highest interference level and the interference area having a relatively high interference level using a transparent cuboid group. The image processing unit 103c may three-dimensionally display, on the display unit 15, an area where the effect of the interference is less than the threshold using a colored cuboid group. As a result, the user can easily confirm (grasp) that the three-dimensional path does not pass through the interference area by confirming whether or not a part of the three-dimensional path appears to protrude from the transparent interference area.

Next, an operation example of the interference evaluation device 1c will be described.

FIG. 19 is a flowchart illustrating an operation example of the interference evaluation device 1c according to the third embodiment. Following step S103 of FIG. 3, the evaluation range derivation unit 100 sets a path range 220 in the evaluation range 200 by a user operation similar to the user operation of setting the evaluation range 200 on the map. The interference derivation unit 102c derives an interference level for the representative point 222 of a sub-space 221 constituting the path range 220 set using the map. The interference derivation unit 102c may derive an interference level for the representative point 203 of a sub-space 202 constituting the path range 220 set using the map (step S107).

The interference evaluation needs to be executed for the three-dimensional path on which a flying body (such as a drone) that can be an interfered station flies. Therefore, a three-dimensional path to be subjected to the interference evaluation is set (step S108).

The display unit 15 displays the result of the interference evaluation for each vertical cross-section dividing the set three-dimensional path (step S109). The image processing unit 103c three-dimensionally displays, on the display unit 15, an area where the effect of the interference is equal to or greater than the threshold using a colored cuboid group. The image processing unit 103c three-dimensionally displays, on the display unit 15, an area where the effect of the interference is less than the threshold using a transparent cuboid group (step S110).

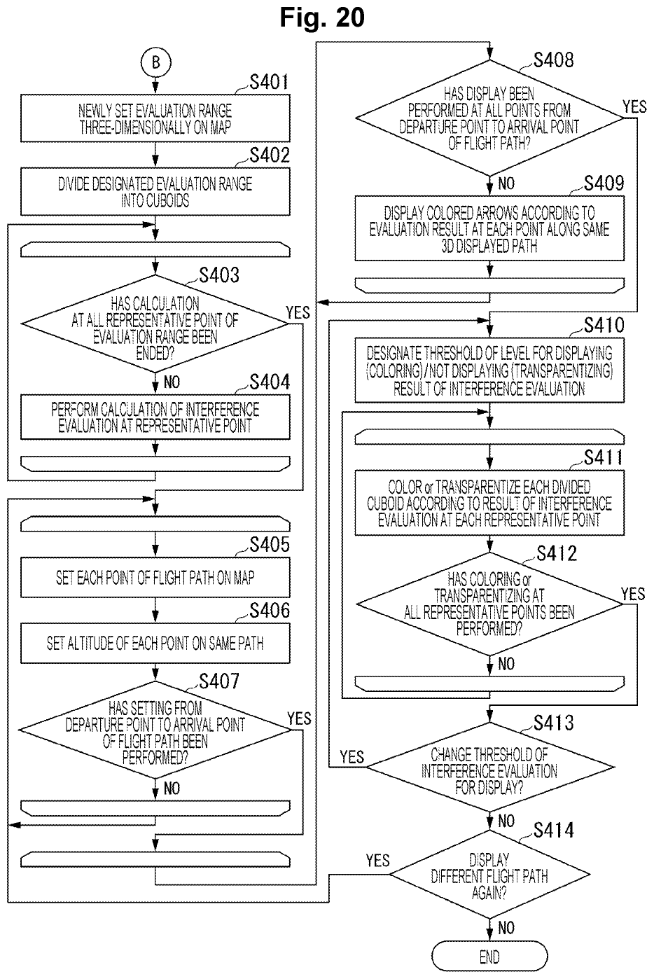

FIG. 20 is a flowchart illustrating details of the operation example of the interference evaluation device 1c according to the third embodiment. The flowchart of FIG. 20 includes four stages. In the first stage, the setting of the path range 220 (three-dimensional evaluation range) and the derivation of the interference level at the representative points of all the sub-spaces are executed. In the second stage, a three-dimensional path to be subjected to the interference evaluation is set. In the third stage, the result of the interference evaluation is three-dimensionally displayed for each vertical cross-section dividing the set three-dimensional path. In the fourth stage, a threshold of an interference level is designated. In addition, the image processing unit 103c three-dimensionally displays, on the display unit 15, an area in which the effect of the interference is equal to or greater than the threshold and an area in which the effect of the interference is less than the threshold. After the fourth stage, processing of confirming to the user whether or not a change in threshold and a change of the three- dimensional path are necessary may be executed.

Each processing from step S401 to step S404 in the first stage is the same as each processing from step S301 to step S304 illustrated in FIG. 14. The processing of step S405 in the second stage is the same as the processing of step S306 illustrated in FIG. 14. The processing of step S406 in the second stage is the same as the processing of step S307 illustrated in FIG. 14. The processing of step S407 in the second stage is the same as the processing of step S305 illustrated in FIG. 14.

In the third stage, the image processing unit 103c determines whether or not the display of all the three-dimensional path passing points between the departure point 230 and the arrival point 238 of the three-dimensional path has been completed (step S408). When the display of any of the three-dimensional path passing points has not been completed (step S408: NO), the image processing unit 103c displays colored arrows corresponding to the interference evaluation result on the display unit 15 for each of the three-dimensional path passing points between the departure point 230 and the arrival point 238 of the three-dimensional path (step S409).

In the fourth stage, the image processing unit 103c acquires a threshold for determining whether or not to color the evaluation result of interference from the storage device 12 or the operation unit 14 (step S410). The image processing unit 103c colors or transparentizes the sub-space 221 (cuboid) according to the evaluation result of interference at each representative point 222. Here, the image processing unit 103c colors an interference area in which the interference level is equal to or higher than the threshold in the three-dimensionally displayed path range 220 (three-dimensional evaluation range). The image processing unit 103c transparentizes an interference area in which the interference level is less than the threshold in the three-dimensionally displayed path range 220 (step S411).

The image processing unit 103c determines whether or not all the sub-spaces 221 or the representative points 222 in the three-dimensionally displayed path range 220 have been colored or transparentized (step S412). When any of the sub-spaces 221 or the representative points 222 in the path range 220 is not colored or transparentized (step S412: NO), the image processing unit 103c returns the processing to step S411.

When all the sub-spaces 221 or the representative points 222 in the path range 220 are colored or transparentized (step S412: YES), the image processing unit 103c confirms to the user whether or not to change the threshold of the interference evaluation for the display (step S413). When the threshold of the interference evaluation is changed (step S413: YES), the image processing unit 103c returns the processing to step S410. In a case where the threshold of the interference evaluation is not changed (step S413: NO), the image processing unit 103c confirms to the user whether to set the three-dimensional path again (step S414). The processing of step S414 is the same as the processing of step S310 illustrated in FIG. 14.

As described above, the image processing unit 103c displays the interference area indicating the distribution of the interference levels on the display unit 15 as a three-dimensional image. As a result, it is possible to three-dimensionally display the result of the interference evaluation with respect to the three-dimensional evaluation range so that the user can easily select the three-dimensional path in which the aerial object equipped with a radio station is less likely to be affected by the interference while reducing the time and effort of the operation of designating the radio wave interference evaluation condition.

In the interference evaluation for a radio station the installation position of which is fixed and a portable radio station, the result of the interference evaluation may be indicated on a two-dimensional map corresponding to the ground. On the other hand, in the interference evaluation for a radio station mounted on an unmanned aerial object (flying body) such as a drone, the user can easily select a three-dimensional path in which the aerial object is less likely to be affected by the interference by three-dimensionally displaying the result of the interference evaluation for a three-dimensional evaluation range.

### Modification of Third Embodiment

The modification of the third embodiment is different from the third embodiment in that the interfering station 210 is installed inside the path range 220. In the modification of the third embodiment, the differences from the third embodiment will be mainly described.

When the interference area is indicated by three-dimensional display as in the third embodiment, the interfering station 210 is installed outside the path range 220. The effect on the interference in the flying body equipped with an interfered station is reduced without changing the position of the interfering station 210 (transmitting station). In addition, the interfering station 210 may be at a high position, and a higher terrain (ridge 300) may exist between the interfering station 210 and the path range 220.

On the other hand, in the modification of the third embodiment, the effect on the interference in the flying body equipped with an interfered station is reduced by changing the position of the interfering station 210 (transmitting station).

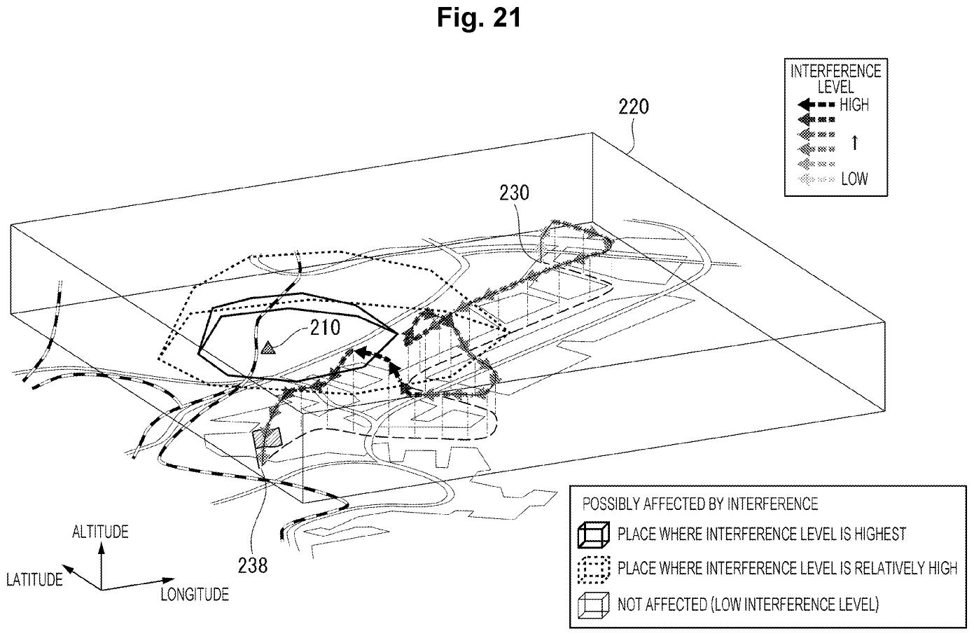

FIG. 21 is a diagram illustrating an example of a screen of an interference evaluation result of a three-dimensional path according to the modification of the third embodiment. In FIG. 21, the interfering station 210 is disposed within the path range 220. The image processing unit 103c three-dimensionally displays, on the display unit 15, the interference area having the highest interference level using, for example, a red cuboid group (similarly to FIGS. 17 and 18, in FIG. 21, a three-dimensional shape of a thick solid line) within the path range 220. In addition, the image processing unit 103c three-dimensionally displays, on the display unit 15, the interference area having a relatively high interference level using, for example, an orange cuboid group (similarly to FIG. 18, in FIG. 21, a three-dimensional shape of a dotted line) within the path range 220.

The image processing unit 103c displays colored arrows (in FIG. 21, arrows from black arrow to light gray arrow) corresponding to the interference evaluation result on the display unit 15 for each of the three-dimensional path passing points between the departure point 230 and the arrival point 238 of the three-dimensional path. In FIG. 21, as an example, an orange arrow (in FIG. 21, the second darkest arrow) indicating a relatively high interference level is present on a portion of the three-dimensional path. With such display, the user can easily grasp that there is a three-dimensional path passing point having a relatively high interference level in the three-dimensional path.

In addition, in order to change the three-dimensional path so as to eliminate the three-dimensional path passing point having a relatively high interference level, the user can easily grasp that it is sufficient if the altitude of the three-dimensional path passing point having a relatively high interference level is changed to about 1.5 times.

As described above, the interfering station 210 may be disposed within the path range 220 that is a three-dimensional evaluation range. The image processing unit 103c three-dimensionally displays, on the display unit 15, the interference area having the highest interference level using, for example, a red cuboid group (in FIG. 21, a three-dimensional shape of a thick solid line) within the path range 220. In addition, the image processing unit 103c three-dimensionally displays, on the display unit 15, the interference area having a relatively high interference level using, for example, an orange cuboid group (in FIG. 21, a three-dimensional shape of a broken line) within the path range 220.

As a result, it is possible to three-dimensionally display the result of the interference evaluation with respect to the three-dimensional evaluation range so that the user can more easily select the three-dimensional path in which the aerial object equipped with a radio station is less likely to be affected by the interference while reducing the time and effort of the operation of designating the radio wave interference evaluation condition.

### Fourth Embodiment

The processing of the first to fourth embodiments may be executed all at once.

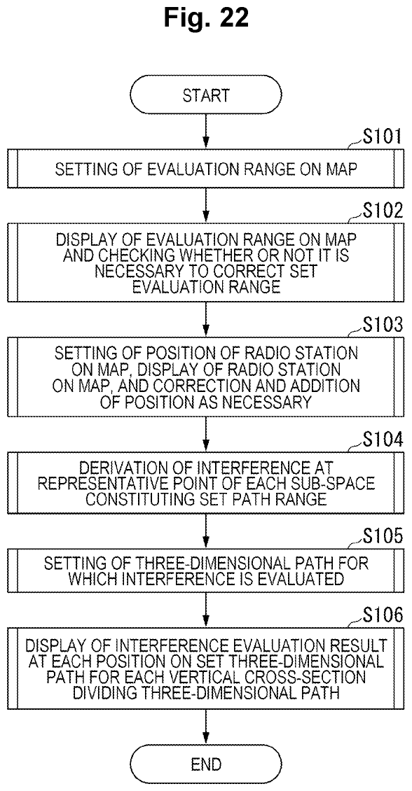

FIG. 22 is a flowchart illustrating a first example of an operation of an interference evaluation device according to the fourth embodiment. Each processing from step S101 to step S103 illustrated in FIG. 22 is the same as each processing from step S101 to step S103 illustrated in FIG. 3. In addition, each processing from step S104 to step S106 illustrated in FIG. 22 is the same as each processing from step S104 to step S106 illustrated in FIG. 13.

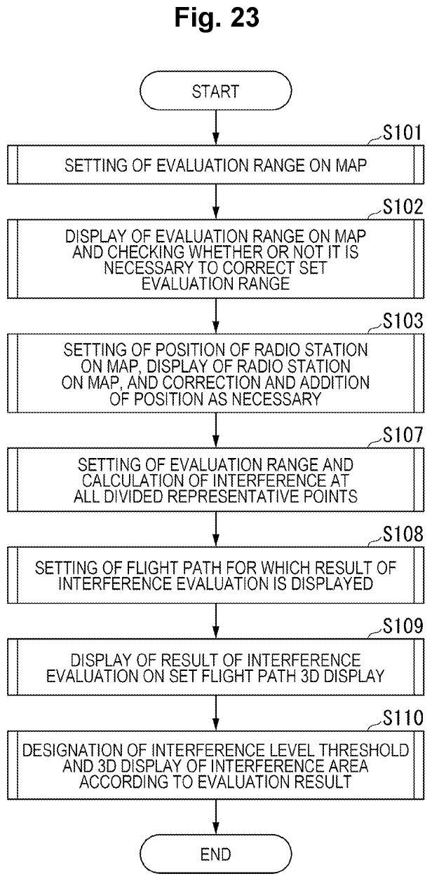

FIG. 23 is a flowchart illustrating a second example of an operation of an interference evaluation device according to the fourth embodiment. Each processing from step S101 to step S103 illustrated in FIG. 23 is the same as each processing from step S101 to step S103 illustrated in FIG. 3. In addition, each processing from step S107 to step S110 illustrated in FIG. 23 is the same as each processing from step S107 to step S110 illustrated in FIG. 19.

As described above, each processing of the first to fourth embodiments may be executed all at once. As a result, it is possible to three-dimensionally display the result of the interference evaluation with respect to the three-dimensional evaluation range so that the user can more easily select the three-dimensional path in which the aerial object equipped with a radio station is less likely to be affected by the interference while reducing the time and effort of the operation of designating the radio wave interference evaluation condition.

### Hardware Configuration Example

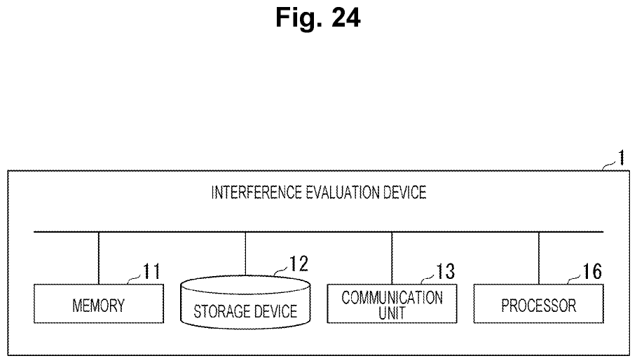

FIG. 24 is a diagram illustrating a hardware configuration example of the interference evaluation device 1 according to each embodiment. The interference evaluation device 1 corresponds to the interference evaluation device 1a of the first embodiment, the interference evaluation device 1b of the second embodiment, and the interference evaluation device 1c of the third embodiment.

Some or all of the functional units of the interference evaluation device 1 are implemented as software by a processor 16 such as a central processing unit (CPU) executing a program stored in the storage device 12 including a non-volatile recording medium (non-transitory recording medium) and the memory 11. The program may be recorded in a computer-readable recording medium. The computer-readable recording medium is, for example, a portable medium such as a flexible disk, a magneto-optical disc, read-only memory (ROM), or compact disc read-only memory (CD-ROM), or a non-transitory recording medium such as a storage device such as a hard disk or a solid state drive (SSD) built in a computer system.

Some or all of the functional units of the interference evaluation device 1 may be implemented by use of hardware including an electronic circuit (electronic circuit or circuitry) in which, for example, a large scale integrated circuit (LSI), an application specific integrated circuit (ASIC), a programmable logic device (PLD), a field programmable gate array (FPGA), or the like is used.

Although the embodiments of this invention have been described in detail with reference to the drawings, the specific configuration is not limited to the embodiments, and includes design and the like without departing from the gist of this invention.

### INDUSTRIAL APPLICABILITY

The present invention is applicable to an information processing device that evaluates interference of radio waves such as wireless communication on a map in interference evaluation software.

### REFERENCE SIGNS LIST

1, 1a, 1b, 1c Interference evaluation device
10a, 10b, 10c Control unit
11 Memory
12 Storage device
13 Communication unit
14 Operation unit
15 Display unit
16 Processor
100 Evaluation range derivation unit
101 Position derivation unit
102a, 102b, 102c Interference derivation unit
103a, 103b, 103c Image processing unit
104 Path range derivation unit
105 Three-dimensional path derivation unit
200 Evaluation range
201 Pointer
202 Sub-space
203 Representative point
210 Interfering station
220 Path range
221 Sub-space
222 Representative point
223 Representative point direction vector
230 Departure point
231 Three-dimensional path passing point
232 Three-dimensional path passing point
233 Three-dimensional path passing point
234 Three-dimensional path passing point
235 Three-dimensional path passing point
236 Three-dimensional path passing point
237 Three-dimensional path passing point
238 Arrival point
300 Ridge
301 First obstacle
302 Second obstacle
400 Interfering/interfered information setting field
410 Area designation setting field
420 Interfering station antenna direction setting field
430 Radio station position setting field

1. An interference evaluation method executed by an interference evaluation device, the interference evaluation method comprising:
deriving coordinates of an evaluation range in a real space on a basis of a first range designated using a map;
deriving coordinates of a radio station in the real space on the basis of a position designated using the map;
deriving an interference level of a radio wave transmitted from the radio station for the evaluation range on the basis of the coordinates of the evaluation range and the coordinates of the radio station; and
displaying an image corresponding to the interference level on a display unit.

2. The interference evaluation method according to claim 1, further comprising:
deriving coordinates of a path range that comprises a three-dimensional path in the real space on the basis of a second range designated within the first range using the map; and
deriving coordinates of the three-dimensional path on the basis of a path designated using the map,
wherein deriving the interference level for the evaluation range further comprises deriving the interference level for the path range, and
wherein displaying the image on the display unit further comprises displaying an image corresponding to the interference level in the three-dimensional path on the display unit.

3. The interference evaluation method according to claim 2, wherein displaying the image on the display unit further includes comprises displaying an interference area indicating a distribution of the interference levels on the display unit as a three-dimensional image.

4. An interference evaluation device comprising:
a position derivation unit, including one or more processors, configured to:
derive coordinates of an evaluation range in a real space on a basis of a first range designated using a map;
derive coordinates of a radio station in the real space on the basis of a position designated using the map;
an interference derivation unit, including one or more processors, configured to derive an interference level of a radio wave transmitted from the radio station for the evaluation range on the basis of the coordinates of the evaluation range and the coordinates of the radio station; and
an image processing unit, including one or more processors, configured to display an image corresponding to the interference level on a display unit.

5. The interference evaluation device according to claim 4, further comprising:
a path range derivation unit, including one or more processors, configured to derive coordinates of a path range that can include a three-dimensional path in the real space on the basis of a second range designated within the first range using the map; and
a three-dimensional path derivation unit, including one or more processors, configured to derive coordinates of the three-dimensional path on the basis of a path designated using the map, wherein
the interference derivation unit is configured to derive the interference level for the path range, and
the image processing unit is configured to display an image corresponding to the interference level in the three-dimensional path on the display unit.

6. The interference evaluation device according to claim 5, wherein the image processing unit is configured to display an interference area indicating a distribution of the interference levels on the display unit as a three-dimensional image.

7. An interference evaluation program for causing a computer to function as the interference evaluation device according to claim 4.
